(19) United States
(12) Patent Application Publication
(10) Pub. No.: US 2004/0230601 A1
(43) Pub. Date: Nov. 18, 2004

(54) Apparatus and method for facilitating shipping commerce

(76) Inventors: Raymond A. Joao, Yonkers, NY (US); Leo J. Mangan, Lindenhurst, NY (US); John A. Notarianni, Lindenhurst, NY (US)

Correspondence Address: WHITE & CASE LLP, PATENT DEPARTMENT, 1155 AVENUE OF THE AMERICAS, NEW YORK, NY, 10036, US

(21) Appl. No.: 10/657,918

(22) Filed: Sep. 9, 2003

Related U.S. Application Data
(60) Provisional application No. 60/409,144, filed on Sep. 9, 2002.

(51) Int. Cl. G06F 17/00

(52) U.S. Cl. 707/102

(57) ABSTRACT

An apparatus and method for providing shipment information, including a receiver for receiving a request to obtain information regarding at least one of a shipment and a delivery, wherein the request is received from a requesting individual, a processor for processing the request to obtain information in conjunction with information regarding at least one of a shipment assignment, a shipment job, a delivery assignment, and a delivery job, and further wherein the processor generates a report in response to the request for information, and a transmitter for transmitting the report to a communication device associated with the requesting individual.

### CROSS-REFERENCE TO RELATED APPLICATION

This application claims priority to U.S. provisional application serial No. 60/409,144, filed Sep. 9, 2002, the disclosure of which is incorporated herein in its entirety.

### FIELD OF THE INVENTION

The present invention pertains to an apparatus and a method for facilitating shipping commerce and, in particular, to an apparatus and a method for facilitating shipping commerce and/or for processing information regarding trucking services, shipping services, cargo transportation services, carrier services, and/or delivery services, in a network environment.

### BACKGROUND OF THE INVENTION

The transportation and shipping industries accounted for approximately $482 Billion in revenues in 1999. This figure includes revenues from land, air, water, truck, rail, and intermodal market sectors of the transportation and shipping industries. The land transportation and shipping market sectors, including trucking transportation and shipping alone, accounted for approximately $394 Billion in 1999.

There is no doubt that the transportation and shipping industries are industries of enormous proportion, rivaling in revenues other large industries such as the travel industries, the financial services industries, the software and technology industries, the automobile industries, and the list can go on. Despite the size of the transportation and shipping industries and their importance to the global economy, there are numerous drawbacks and shortfalls associated therewith which continue to prevent the transportation and shipping industries from achieving their true potential in revenue growth and operating efficiencies.

There are numerous drawbacks and shortfalls associated with the transportation and shipping industries. While applicable to all market sectors, these drawbacks and shortfalls can be clearly understood and appreciated when they are explained in the context of how they adversely affect the land transportation and trucking sectors.

Communications between providers of transportation and shipping services and clients and/or potential clients of these providers are severely limited. This has resulted in gross inefficiencies in providers transporting shipments with large amounts of unused cargo capacity, the inability of providers to obtain up-dated information regarding the character, nature and credit ratings of their counterparts and clients, the inability of providers to collect fees for services rendered in a timely fashion, and the limited communication channels which can from time to time cause providers to have to rely on transportation brokers and freight consolidators or brokers who or which may also be limited in the type and quality of services which they can provide to these transportation and shipping providers.

It is not uncommon for a provider or truck driver to transport a shipment of goods, make a delivery and head to his next destination with an empty truck or cargo bay. Similarly, it is not uncommon for a provider or truck driver to travel at less than full capacity. Both of these scenarios result in inefficiencies. The provider or truck driver losses revenues by not traveling at full capacity. A potential client may not get its shipment effected at the soonest possible time or for the lowest possible cost.

Providers, truck drivers and clients also have to be concerned about the counterparty they are dealing with. These concerns can include the party's ability to honor its end of the bargain, the ability for a provider to effect a shipment in a timely and careful manner and/or the client's ability to effect a pick-up, a delivery, and/or to pay for services rendered. In the world of land transportation, it is very difficult to know the true character, integrity, and creditworthiness of your counterparty or counterparties.

Reliance on brokers and consolidators can also present problems which can result from lack of information between or about the various providers, clients and brokers. The lack of communication breeds a lack of familiarity and with same the inability to sometimes know the party with whom you are dealing.

It is easy to see that the lack of effective communications, which currently exists in the transportation and shipping industries, has prevented these industries from reaching their potential. Further, with the exponential growth of e-commerce and the shipping and transportation requirements associated therewith, there is a great need to overcome the shortfalls of the existing transportation and shipping industries and/or the shortfalls with the communication systems and practices which are utilized in conjunction with these industries.

### SUMMARY OF THE INVENTION

The present invention pertains to an apparatus and a method for facilitating shipping commerce which overcomes the shortfalls of the prior art. The present invention pertains to an apparatus and a method for facilitating shipping commerce and, in particular, to an apparatus and a method for facilitating shipping commerce and/or for processing information regarding trucking services, shipping services, cargo transportation services, carrier services, and/or delivery services, in a network environment. The apparatus and method of the present invention facilitates bringing together clients or other individuals or entities who or which require shipping services, in order to ship goods, products, equipment, and/or any other item or items, with providers of shipping services such as truckers, transportation services, cargo transportation services, carrier services, and/or delivery services.

The apparatus and method of the present invention can also process any data and/or information necessary in identifying, establishing, and effectuating, relationships, agreements related thereto, and/or for providing any administrative or ancillary support or services related thereto.

The apparatus and method of the present invention can be utilized by clients to find and/or secure shipping, transportation and/or delivery services for any goods, products, equipment, and/or item or items, which the clients desire to ship, transport, or have delivered. The apparatus and method of the present invention can also be utilized by shipping providers, trucking service providers, transportation service providers, and/or delivery service providers, in order to identify and locate clients in need of their services.

The apparatus and method of the present invention can bring together clients and shipping providers, trucking service providers, transportation service providers, carrier services, and/or delivery service providers, in a network environment. The present invention can also provide a forum and/or a platform from which any of the herein-described clients and providers can identify parties to negotiate with and/or to contract with, and/or can also provide a forum or platform for facilitating the executing of agreements and/or contracts regarding and/or involving shipping, trucking, transportation, and delivery contracts and/or services.

The apparatus and method of the present invention can also process any data and/or information for or regarding any of the parties and/or services described herein as well as provide administrative services for, or on behalf of, any of the parties described herein.

The apparatus and method of the present invention can be utilized in a network environment in order to effectuate any of the services described herein.

The apparatus includes a central processing computer or server computer. The central processing computer provides control over the apparatus and provides services for the various computers associated with the various individuals and users of the present invention and/or the information and services provided thereby. Any number of central processing computers may be utilized in order to provide the functions described herein.

The apparatus can also include one or more client computers which can be utilized by any of the various clients described herein. The apparatus can also include one or more provider computers which can be utilized by any of the various providers.

Each of the client computer(s) and each of the provider computer(s) described herein can transmit information to the central processing computer(s) as well as receive information from the central processing computer(s). In addition, each client computer can also transmit information to any provider computer as well as receive information from any provider computer. In a similar manner, each provider computer can transmit information to any client computer as well as receive information from any client computer.

Each of the provider computers, the client computers, and/or the central processing computer(s), can be wireless communication devices, and/or can be computers or other processing devices which can operate in a wireless communication environment, in a wired or line-connected environment, and/or in any combination and/or hybrid environment(s).

The central processing computer(s), the client computer(s), and/or the provider computer(s), can communicate with one another, and/or be linked to one another, over a communication network and/or a wireless communication network. The present invention is utilized on, and/or over, the Internet and/or the World Wide Web and/or any other communication network. The present invention can also utilize wireless Internet and/or World Wide Web services, equipment and/or devices. The central processing computer(s) can also have a web site or web sites associated therewith.

The present invention can also be utilized with any appropriate communication systems including, but not limited to, network communication systems, telephone communication systems, cellular communication systems, digital communication systems, personal communication systems, personal communication services (PCS) systems, third generation (3G) communication systems, satellite communication systems, broad band communication systems, low earth orbiting (LEO) satellite systems, and/or public switched telephone networks or systems.

The central processing computer can include a central processing unit, a random access memory device, a read only memory device, a user input device, a display device, a transmitter(s), a receiver, a database, and an output device.

The database can contain any and/or all of the data and/or information needed and/or desired for performing any and/or all of the functions and/or processing routines described herein.

The client computer can include a central processing unit, a random access memory device, a read only memory device(s), a user input device, a display device, a transmitter(s), a receiver, a database, and an output device. The client computer can also include a position and/or location device.

The provider computer can include a central processing unit, a random access memory device, a read only memory device(s), a user input device, a display device, a transmitter(s), a receiver, a database, and an output device. The provider computer can also include a position and/or location device.

The databases of the client computer(s) and/or the provider computer(s) can contain any and/or all of the data and/or information which is stored and/or contained in the database of the central processing computer.

Any of the computers described herein can communicate with one another via electronic submissions, electronic form submissions and/or transmissions, e-mail transmissions, facsimile transmissions, telephone messages, telephone calls, physical mail delivery, and/or via any other suitable communication technique, medium, or method.

The apparatus and method of the present invention can be utilized in order to provide numerous services to or for any of the herein-described clients and/or providers.

The apparatus and method of the present invention can be utilized by providers in order to search for and/or to locate shipping or delivery assignments or jobs and/or to enter into a shipment and/or delivery agreement and/or any other agreement and/or arrangement. The present invention can also facilitate the provider(s) and client(s) participating in an auction or bidding process regarding the buying or selling of provider services and/or the selling or buying of client assignments or jobs.

The apparatus and method of the present invention can also be utilized by a broker, an agent, and/or a representative, of a provider or group of providers, and/or by any other third party, in order to identify shipping or delivery assignments or jobs, for any of the providers or truck drivers described herein.

The apparatus and method of the present invention can also be utilized by clients in order to search for and/or to locate a shipping or delivery provider who or which may be able to fulfill their shipping or delivery needs. The present invention can also facilitate the client(s) and provider(s) participating in an auction or bidding process regarding the buying or selling of client assignments or jobs and/or the selling or buying of provider services.

The apparatus and method of the present invention can also be utilized by a broker, an agent, and/or a representative, of a client or group of clients, and/or by any other third party, in order to identify a provider(s) of any of the herein-described shipping or delivery services, for any of the clients described herein.

The present invention can also be utilized in order to provide an on-line auction environment. The auction can be for auctioning off services of any of the various providers described herein, auctioning off the assignments and/or jobs which can be offered by any of the clients described herein. The auction can also be for bidding for the services of any of the providers described herein. The auction can also be for bidding for assignments and/or jobs offered by any of the clients described herein. The auction or auctions facilitated by the apparatus and method of the present invention can also be a combination and/or a hybrid of any of the various auctions described herein.

The apparatus and method of the present invention can also be utilized in order to allow a provider of shipping or delivery services to provide updates of his, her, or its, location and/or available cargo capacity. In this manner, the provider can provide notice to any potential clients of his, her, or its, location and capacity to pick-up a load for shipment and/or for delivery.

The apparatus and method of the present invention can also be utilized so as to monitor information regarding the shipping or delivery needs of any number of clients against location or position updates and available cargo capacity for any number of providers in order to provide a dynamic clearinghouse for matching clients needs with available providers. Further, the apparatus and method of the present invention can also be utilized by a broker, an agent, and/or a representative, of a client or group of clients, and/or by any other third party, in order to utilize the above-described embodiment on behalf of any of the respective parties.

In another preferred embodiment, the apparatus and method of the present invention can be utilized in order to allow a client of shipping or delivery services to post his, her, or its location and shipment or delivery needs. In this manner, the client can provide notice to any potential providers of his, her, or its, location and requirements and/or needs for a shipment or delivery. The client can also post its shipment or delivery requirements at the start of a pre-specified period and, thereafter, report all shipments or deliveries made to date.

The information regarding the shipment or delivery requirements of the client can be entered by the client or its representative and/or by other providers as they provide shipment or delivery services for the client. Shipment or delivery information can also be monitored, either manually and/or automatically, by utilizing a scanner device, a bar code scanner, and/or any other monitoring equipment which can monitor cargo or shipments as they are loaded and/or unloaded from the vehicle. For example, scanning devices and/or scanners having sufficient reaching capabilities and/or long range scanning capabilities can be utilized in conjunction with the present invention in order to detect and/or identify a load as it is being loaded and/or unloaded from the vehicle.

The apparatus and method of the present invention can also be utilized in order to automatically monitor information regarding the shipment or delivery requirements of any number of clients against the availability of any number of providers in order to provide a dynamic clearinghouse for matching clients needs with available providers.

The apparatus and method of the present invention can be utilized by a broker, an agent, and/or a representative, of a client or group of clients, and/or by any other third party, in order to utilize the above-described embodiment on behalf of any of the respective parties.

The apparatus and method of the present invention can also be utilized in order to provide a provider with digitized map information displaying the location of any clients in the provider's geographic or physical proximity who or which have or may have shipment or delivery requirements which need to be fulfilled or which may need to be fulfilled. The present invention can also provide a system for enabling a provider to identify assignment and/r job opportunities and enter into agreements for same from a mobile platform and/or from his or her present location.

In another preferred embodiment, the digitized map or maps can be updated as a provider enters a new or different area or region of interest which may have new client postings, thereby providing updated client identification and location information. The digitized map or maps can also be updated as new clients become available in a given area or region.

The apparatus and method of the present invention can be utilized in order to provide a client with a digitized map displaying the location of any providers in the client's geographic or physical area or proximity who are or who may be available to handle any shipment or delivery needs of the client. The present invention can also be utilized in order to provide a system for enabling a client to identify providers who may fulfill its shipment or delivery requirements or needs and enter into agreements for obtaining these respective services.

The digitized map or maps can also be updated as new or different providers enters an area or region of interest, thereby providing updated provider identification and location information. The digitized map or maps can also be updated as new providers become available in a given area or region.

The present invention can also be utilized to provide a provider with notification upon the posting of shipment and/or delivery assignments by any of the clients described herein. The present invention can also be utilized in order to provide a client with notification upon the posting by any provider(s) of their availability to perform shipment or delivery services.

The apparatus and method of the present invention can also be utilized in order to provide various services for and/or on behalf of any of the respective providers and/or clients who or which utilize the present invention. The present invention can also be utilized to provide information and/or services for a wide variety of subject areas, such as, but not limited to, providing contract formation services, providing contracts, providing shipping invoices, providing bills of lading, providing packing slips, providing and/or performing billing services, providing insurance information, products, and/or services, providing and/or performing fee collection services, and/or providing and/or performing any other information or services which may be related to and/or which may be incidental to any of the relationships which are described herein.

The present invention can also be utilized in order to administer and/or manage financial accounts for any of the providers and/or clients described herein as well as effect financial and/or monetary transfers to, from, and/or between, any of the financial accounts for any of the parties described herein. In this manner, the present invention can provide a billing and payment clearing platform for any of the financial transactions which can be facilitated by the apparatus and method of the present invention.

The present invention can also be utilized in order to monitor and/or track a shipment or delivery by monitoring the position or location information of the provider handling same.

The present invention, in any and/or all of the embodiments described herein, can also be programmed to be self-activating and/or activated automatically.

The present invention can also be utilized to monitor and/or record information regarding any of the herein-described interactions, negotiations, and/or deals reached, between any of the parties described herein as utilizing the present invention.

The present invention, in any and/or all of the herein-described embodiments, can utilize electronic commerce technologies and security methods, and/or techniques and/or technologies.

The present invention can be utilized in conjunction with positioning and/or location devices, systems, and/or technologies, including but not limited to, global positioning system technologies, triangulation technologies, ESN triangulation technologies, wireless location system technologies, tracking technologies, time difference of arrival locating technologies, and/or any other positioning and/or locating devices, systems and/or technologies.

Any of the data and/or information stored in the database or in the collection of databases described herein can be updated by each of the respective individuals and/or entities described herein, and/or an administrator or operator of the apparatus of the central processing computer via database management techniques.

The apparatus and method of the present invention can be utilized by any of the herein-described providers and clients so as to facilitate improved services and efficiencies in the shipment, transportation, and delivery, services fields and industries.

The apparatus and method of the present invention can be utilized to facilitate various electronic commerce activities and/or related activities in the shipping, transporting, cargo transporting, and/or delivery fields and/or industries.

Any of the providers and/or clients described herein as utilizing the apparatus and method of the present invention can obtain data and/or information from the present invention in real-time and/or otherwise. In this manner, any data transmissions and/or any communications which can take place between any of the parties described herein and/or any of the central processing computers, the client computers and/or communication devices, and/or the provider computers and/or communication devices, described herein, can take place in real-time and/or otherwise.

The present invention can also be utilized in conjunction with dispatching algorithms and/or software programs and/or routines which can process dispatch and/or dispatching information. The dispatch information can be processed as a function of provider position, provider available cargo capacity, priority of load, cargo type, provider past performance rating and/or information, and/or any other information and/or factors which can or should be considered in processing dispatch or dispatching information.

The apparatus and method of the present invention can also be utilized in transactions involving commerce of any kind, electronic commerce (e-commerce), and/or mobile commerce (m-commerce).

Accordingly, it is an object of the present invention to provide an apparatus and a method for facilitating shipping commerce.

It is another object of the present invention to provide an apparatus and method for facilitating shipping or delivery commerce.

It is still another object of the present invention to provide an apparatus and method for facilitating shipping commerce, in a network environment.

It is yet another object of the present invention to provide an apparatus and method for facilitating shipping or delivery commerce, in a network environment.

It is another object of the present invention to provide an apparatus and method for facilitating shipping commerce, which provides for the processing of information regarding trucking services, shipping services, cargo transportation services, carrier services, and/or delivery services.

It is still another object of the present invention to provide an apparatus and method for facilitating shipping commerce, which provides for the processing of information regarding trucking services, shipping services, cargo transportation services, carrier services, and/or delivery services, in a network environment.

It is yet another object of the present invention to provide an apparatus and method for facilitating shipping commerce, which facilitates bringing together clients or other individuals or entities who or which require shipping or delivery services, with providers of shipping or delivery services.

It is another object of the present invention to provide an apparatus and method for facilitating shipping or delivery commerce, which provides for the processing of information regarding trucking services, shipping services, cargo transportation services, carrier services, and/or delivery services.

It is another object of the present invention to provide an apparatus and method for facilitating shipping or delivery commerce, which provides for the processing of any data and/or information necessary in identifying, establishing, and effectuating, relationships, and/or agreements related to shipping or delivery commerce or service.

It is still another object of the present invention to provide an apparatus and method for facilitating shipping or delivery commerce which facilitates assisting a party to find and/or secure shipping, transportation, and/or delivery services for any goods, products, equipment, and/or item or items, which the party desires to ship, transport, or have delivered.

It is yet another object of the present invention to provide an apparatus and method for facilitating shipping or delivery commerce which facilitates assisting a provider of shipping or delivery services to find and/or secure clients in need of its services.

It is another object of the present invention to provide an apparatus and method for facilitating shipping or delivery commerce which provides a forum and/or a platform from which to identify parties to negotiate with, to contract with and/or to execute agreements and/or contracts for and involving shipping, trucking, transportation, and delivery contracts and/or services.

It is still another object of the present invention to provide an apparatus and method for facilitating shipping or delivery commerce which processes any data and/or information for or regarding any of the parties and/or services described herein.

It is yet another object of the present invention to provide an apparatus and method for facilitating shipping or delivery commerce which provides information processing regarding administrative services for, or on behalf of, any of the parties described herein.

It is another object of the present invention to provide an apparatus and method for facilitating shipping or delivery commerce which can be utilized in conjunction with any appropriate and/or suitable communication network.

It is another object of the present invention to provide an apparatus and method for facilitating shipping or delivery commerce which can be utilized in conjunction with the Internet and/or the World Wide Web.

It is still another object of the present invention to provide an apparatus and method for facilitating shipping or delivery commerce which can be utilized in conjunction with a wireless communication network.

It is yet another object of the present invention to provide an apparatus and method for facilitating shipping or delivery commerce which can be utilized in conjunction with a wireless Internet and/or a wireless World Wide Web communication network.

It is another object of the present invention to provide an apparatus and method for facilitating shipping or delivery commerce which can be utilized in conjunction with wireless communication devices and/or wireless computers.

It is another object of the present invention to provide an apparatus and method for facilitating shipping or delivery commerce which can be utilized in conjunction with third generation (3G) communication devices.

It is still another object of the present invention to provide an apparatus and method for facilitating shipping or delivery commerce which can facilitate communication services via electronic submissions, electronic form submissions and/or transmissions, e-mail transmissions, facsimile transmissions, telephone messages, telephone calls, physical mail delivery, and/or via any other suitable communication technique, medium, or method.

It is still another object of the present invention to provide an apparatus and method for facilitating shipping or delivery commerce which can be utilized by providers in order to search for and/or to locate shipping or delivery assignments or jobs.

It is yet another object of the present invention to provide an apparatus and method for facilitating shipping or delivery commerce which can facilitate an auction or bidding process regarding the buying or selling of provider services and/or the selling or buying of client assignments or jobs.

It is another object of the present invention to provide an apparatus and method for facilitating shipping or delivery commerce which can be utilized by clients in order to search for and/or to locate a shipping or delivery provider who or which may be able to fulfill their shipping or delivery needs.

It is still another object of the present invention to provide an apparatus and method for facilitating shipping or delivery commerce which can be utilized to facilitate an auction or bidding process regarding the buying or selling of client assignments or jobs and/or the selling or buying of provider services.

It is yet another object of the present invention to provide an apparatus and method for facilitating shipping or delivery commerce which can be utilized to provide an on-line auction environment.

It is another object of the present invention to provide an apparatus and method for facilitating shipping or delivery commerce which can be utilized in order to allow a provider of shipping or delivery services to provide updates of his, her, or its, location and/or available cargo capacity.

It is still another object of the present invention to provide an apparatus and method for facilitating shipping or delivery commerce which can be utilized by a shipping or delivery provider to provide notice to any potentional clients of his, her, or its, location and capacity to pick-up a load for shipment and/or for delivery.

It is yet another object of the present invention to provide an apparatus and method for facilitating shipping or delivery commerce which can be utilized to monitor information regarding the shipping or delivery needs of any number of clients against location or position updates and available cargo capacity for any number of providers in order to provide a dynamic clearinghouse for matching clients needs with available providers.

It is another object of the present invention to provide an apparatus and method for facilitating shipping or delivery commerce which can be utilized in order to allow a client of shipping or delivery services to post his, her, or its location and shipment or delivery needs.

It is still another object of the present invention to provide an apparatus and method for facilitating shipping or delivery commerce which can be utilized by a client to provide notice to any potential providers of the client's location and requirements and/or needs for a shipment or delivery.

It is yet another object of the present invention to provide an apparatus and method for facilitating shipping or delivery commerce which can be utilized to monitor cargo or shipments as they are loaded and/or unloaded from a vehicle.

It is another object of the present invention to provide an apparatus and method for facilitating shipping or delivery commerce which can be utilized in order to monitor information regarding the shipment or delivery requirements of any number of clients against the availability of any number of providers in order to provide a dynamic clearinghouse for matching clients needs with available providers.

It is still another object of the present invention to provide an apparatus and method for facilitating shipping or delivery commerce which can be utilized to provide a provider with digitized map information displaying the location of any clients in the provider's geographic or physical proximity who or which have or may have shipment or delivery requirements which need to be fulfilled or which may need to be fulfilled.

It is yet another object of the present invention to provide an apparatus and method for facilitating shipping or delivery commerce which can be utilized to identify assignment and/or job opportunities and enter into agreements for same from a mobile platform.

It is another object of the present invention to provide an apparatus and method for facilitating shipping or delivery commerce which can be utilized in conjunction with a digitized map or maps which can be updated as the provider enters a new or different area or region.

It is still another object of the present invention to provide an apparatus and method for facilitating shipping or delivery commerce which can be utilized in conjunction with a digitized map or maps which can also be updated as new clients become available in a given area or region.

It is yet another object of the present invention to provide an apparatus and method for facilitating shipping or delivery commerce which can provide a client with a digitized map displaying the location of any providers in the client's geographic or physical proximity who are or who may be available to handle any shipment or delivery needs of the client.

It is another object of the present invention to provide an apparatus and method for facilitating shipping or delivery commerce which can be utilized to enable a client to identify providers who may fulfill its shipment or delivery requirements or needs and enter into agreements for obtaining these respective services.

It is still another object of the present invention to provide an apparatus and method for facilitating shipping or delivery commerce which can be utilized to provide a provider with notification upon the posting of shipment and/or delivery assignments by any of the clients described herein.

It is yet another object of the present invention to provide an apparatus and method for facilitating shipping or delivery commerce which can be utilized to provide a client with notification upon the posting by any provider(s) of their availability to perform shipment or delivery services.

It is another object of the present invention to provide an apparatus and method for facilitating shipping or delivery commerce which can be utilized to provide information and/or services related to shipment and/or delivery services and related activities.

It is still another object of the present invention to provide an apparatus and method for facilitating shipping or delivery commerce which can administer and/or manage financial accounts for any of the providers and/or clients described herein.

It is yet another object of the present invention to provide an apparatus and method for facilitating shipping or delivery commerce which can administer and/or facilitate financial and/or monetary transfers to, from, and/or between, any of the financial accounts for any of the parties described herein.

It is another object of the present invention to provide an apparatus and method for facilitating shipping or delivery commerce which can be utilized to monitor and/or track a shipment or delivery by monitoring the position or location information of the provider handling same.

It is still another object of the present invention to provide an apparatus and method for facilitating shipping or delivery commerce which can be programmed to be self-activating and/or activated automatically.

It is yet another object of the present invention to provide an apparatus and method for facilitating shipping or delivery commerce which can be utilized to monitor and/or record information regarding any of the herein-described interactions, negotiations, and/or deals reached, between any of the parties described herein.

It is another object of the present invention to provide an apparatus and method for facilitating shipping or delivery commerce which can utilize electronic commerce technologies and security methods, and/or techniques and/or technologies.

It is still another object of the present invention to provide an apparatus and method for facilitating shipping or delivery commerce which can facilitate improved services and efficiencies in the shipment, transportation, and delivery, services fields and industries.

It is yet another object of the present invention to provide an apparatus and method for facilitating shipping or delivery commerce which can be utilized to facilitate various electronic commerce activities and/or related activities in the shipping, transporting, cargo transporting, and/or delivery fields and/or industries.

It is another object of the present invention to provide an apparatus and method for facilitating shipping or delivery commerce which can be utilized by a broker, an agent, and/or a representative, of a client or group of clients, and/or of a provider or group of providers, and/or which can be utilized by any other third party, in order to utilize the present invention for or on behalf of any of the respective parties.

It is still another object of the present invention to provide an apparatus and method for facilitating shipping or delivery commerce which can provide data and/or information in real-time and/or otherwise.

It is yet another object of the present invention to provide an apparatus and a method for facilitating shipping or delivery commerce which can provide either manual and/or automatic monitoring of cargo loading and/or unloading.

It is another object of the present invention to provide an apparatus and a method for facilitating shipping or delivery commerce which can be utilized in conjunction with dispatching algorithms and/or dispatching software programs and/or routines.

It is still another object of the present invention to provide an apparatus and method for facilitating shipping or delivery commerce which can be utilized in transactions involving commerce of any kind, electronic commerce, and/or mobile-commerce.

It is yet another embodiment of the present invention to provide an apparatus and method for facilitating shipping or delivery commerce which can utilize position and/or location devices, systems and/or technologies in conjunction therewith.

Other objects and advantages of the present invention will be apparent to those skilled in the art upon a review of the Description of the Preferred Embodiment taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of the apparatus of FIG. 1, in block diagram form;

FIG. 3 illustrates the provider computer of the apparatus of FIG. 1, in block diagram form;

FIG. 4 illustrates the client computer of the apparatus of FIG. 1, in block diagram form;

FIGS. 5A, 5B and 5C illustrate a preferred embodiment operation of the apparatus of FIG. 1, in flow diagram form;

FIGS. 6A, 6B and 6C illustrate another preferred embodiment operation of the apparatus of FIG. 1, in flow diagram form;

FIGS. 7A and 7B illustrate another preferred embodiment operation of the apparatus of FIG. 1, in flow diagram form;

FIGS. 8A and 8B illustrate another preferred embodiment operation of the apparatus of FIG. 1, in flow diagram form;

FIGS. 9A and 9B illustrate another preferred embodiment operation of the apparatus of FIG. 1, in flow diagram form;

FIGS. 10A, 10B and 10C illustrate another preferred embodiment operation of the apparatus of FIG. 1, in flow diagram form;

FIGS. 11A, 11B and 11C illustrate another preferred embodiment operation of the apparatus of FIG. 1, in flow diagram form;

FIGS. 12A and 12B illustrate another preferred embodiment operation of the apparatus of FIG. 1, in flow diagram form;

FIGS. 13A and 13B illustrate another preferred embodiment operation of the apparatus of FIG. 1, in flow diagram form; and

FIGS. 14A and 14B illustrate another preferred embodiment operation of the apparatus of FIG. 1, in flow diagram form.

### DESCRIPTION OF THE PREFERRED EMBODIMENTS

The present invention pertains to an apparatus and a method for facilitating shipping commerce and, in particular, to an apparatus and a method for facilitating shipping commerce and/or for processing information regarding trucking services, shipping services, cargo transportation services, carrier services, and/or delivery services, in a network environment. The apparatus and method of the present invention facilitates bringing together clients or other individuals or entities who or which require shipping services, in order to ship goods, products, equipment, and/or any other item or items, with providers of shipping services such as truckers, transportation services, cargo transportation services, carrier services, and/or delivery services.

The apparatus and method of the present invention can also process any data and/or information necessary in identifying, establishing, and effectuating, relationships, and/or any agreements related thereto, and/or for providing any administrative or ancillary support or services related thereto.

The apparatus and method of the present invention can be utilized by clients to find and/or to secure shipping, transportation and/or delivery services for any goods, products, equipment, and/or item or items, which the clients desire to ship, transport, deliver, and/or have delivered. The apparatus and method of the present invention can also be utilized by shipping providers, trucking service providers, transportation service providers, and/or delivery service providers, in order to identify and to locate clients in need of their services.

The apparatus and method of the present invention can bring together clients and shipping providers, trucking service providers, transportation service providers, carrier service providers, and/or delivery service providers, in a network environment. The present invention can also provide a forum and/or a platform by which to allow any of the parties described herein to identify parties who or which they can negotiate with, contract with, and/or execute agreements and/or contracts with, for and/or involving shipping, trucking, transportation, and/or delivery contracts and/or services. The apparatus and method of the present invention can also process any data and/or information for or regarding any of the parties and/or services described herein as well as provide administrative services for, or on behalf of, any of the parties described herein.

As defined herein, the terms “client”, “customer”, “merchant”, “manufacturer”, “retailer”, “wholesaler”, “importer”, “exporter”, “individual”, “user”, “transportation broker”, or the plurals of same, refer to any client, clients, customer, customers, merchant, merchants, manufacturer, manufacturers, retailer, retailers, wholesaler, wholesalers, importer, importers, exporter, exporters, individual, individuals, user, users, transportation broker, transportation brokers, and/or any agents, brokers, and/or representatives of same, who or which may be in need of finding and/or utilizing the services of shipping providers, trucking service providers, transportation service providers, and/or delivery service providers.

As defined herein, the terms “provider”, “shipper”, “trucker”, “driver”, “transporter”, “carrier”, “trucking service”, “transport service”, “carrier service”, “delivery service”, “shipping provider”, “shipping service provider”, “trucking service provider”, transportation service provider”, “delivery service provider”, “individual”, or “provider”, or the plurals of same, refer to any provider, providers, service provider, service providers, shipper, shippers, trucker, truckers, driver, drivers, transporter, transporters, carrier, carriers, trucking service, trucking services, transport service, transport services, carrier service, carrier services, delivery service, delivery services, shipping provider, shipping providers, shipping service provider, shipping service providers, trucking service provider, trucking service providers, transportation service provider, transportation service providers, delivery service provider, delivery service providers, individual, individuals, and/or any brokers, agents, and/or representatives of same, who or which provide and/or arrange for providing any of the shipping services, trucking services, carrier services, transportation services, and/or delivery services, described herein.

As defined herein the term “vehicle” or the plural of same, refers to any motor vehicle, truck, automobile, boat, marine vessel or vehicle, airplane, aircraft, jet, spacecraft, space vehicle, space shuttle, satellite, or other vehicle which can be utilized by any of the providers of shipping services, transport services, cargo transport services, and/or delivery services.

The apparatus and method of the present invention can be utilized in a network environment in order to effectuate any of the services described herein.

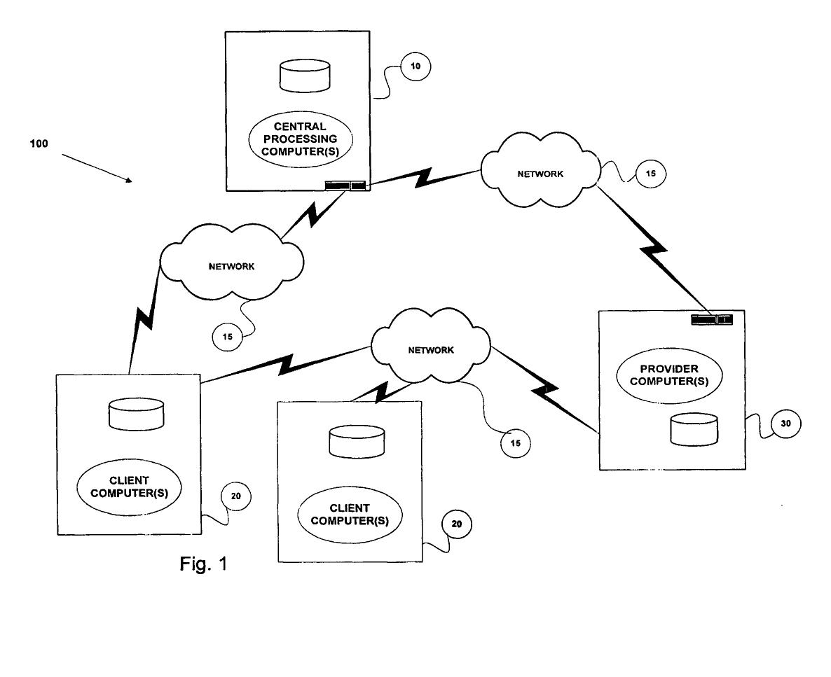

FIG. 1 illustrates a preferred embodiment of the apparatus of the present invention which is designated generally by the reference numeral 100. In FIG. 1, the apparatus 100 includes a central processing computer or server computer 10. The central processing computer 10 provides control over the apparatus 100 and provides services for the various computers associated with the various individuals, users, clients, and/or providers, who or which utilize the present invention and/or the information and services provided thereby.

The central processing computer 10, in the preferred embodiment, can be any suitable computer, network computer, or computer system, for providing service for the various computers associated with the client(s), customer(s), merchant(s), manufacturer(s), retailer(s), wholesaler(s), importer(s), exporter(s), individual(s), user(s), transportation broker(s), agent(s), shipper(s), trucker(s), driver(s), transporter(s), carrier(s), trucking service(s), transport service(s), carrier service(s), delivery service(s), shipping provider(s), shipping service provider(s), trucking service provider(s), transportation service provider(s), delivery service provider(s), or brokers, agents, and/or representatives of same, who or which utilize the present invention.

In the preferred embodiment, any number of central processing computers 10 can be utilized in order to provide the servicing functions described herein. The central processing computer(s) 10 can be linked to other central processing computers or may be stand alone devices. A given central processing computer 10 may service a particular geographic area or certain client(s), customer(s), merchant(s), manufacturer(s), retailer(s), wholesaler(s), importer(s), exporter(s), individual(s), user(s), transportation broker(s), agent(s), provider(s), shipper(s), trucker(s), driver(s), transporter(s), carrier(s), trucking service(s), transport service(s), carrier service(s), delivery service(s), shipping provider(s), shipping service provider(s), trucking service provider(s), transportation service provider(s), delivery service provider(s), or broker(s), agent(s), and/or representative(s) of same, and/or of groups thereof. A central processing computer 10 may also be dedicated to service any one or group of the above described individuals and/or entities.

The apparatus 100, in the preferred embodiment, also includes one or more client computers 20. Each client computer 20 can be a personal computer or other communication device which is suitable for allowing the client to interact with the central processing computer(s) 10. Each client computer 20 can be associated with and any of the client(s), customer(s), merchant(s), manufacturer(s), retailer(s), wholesaler(s), importer(s), exporter(s), individual(s), user(s), transportation broker(s), agent(s), and/or any broker(s), agent(s), and/or representative(s) of same.

Each client computer 20 can be utilized to transmit information to the central processing computer 10 and to receive information from the central processing computer 10 via the communication network.

The client computer 20 can be a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and/or a watch. The client computer 20 can also be a wireless communication device(s). In the present invention, any number of client computers 20 can be utilized. In the present invention, each client or individual utilizing the present invention may have one or more client computers 20 associated therewith.

The apparatus 100, in the preferred embodiment, also includes one or more provider computers 30. Each provider computer 30 may be a personal computer or other communication device suitable for allowing the provider to interact with the central processing computer(s) 10. Each provider computer 30 can be associated with any provider, providers, shipper, shippers, trucker, truckers, driver, drivers, transporter, transporters, carrier, carriers, trucking service, trucking services, transport service, transport services, carrier service, carrier services, delivery service, delivery services, shipping provider, shipping providers, shipping service provider, shipping service providers, trucking service provider, trucking service providers, transportation service provider, transportation service providers, delivery service provider, delivery service providers, individual, individuals, provider or providers, and/or any broker(s), agent(s), and/or representative(s) of same, described herein, who or which may utilize the present invention.

Each provider computer 30 can be utilized to transmit information to the central processing computer 10 and to receive information from the central processing computer 10 via the communication network.

The provider computer 30 can be a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and/or a watch. In the preferred embodiment, the provider computer 30 can be a computer or communication device which is utilized in a wireless communication environment. In the preferred embodiment, any number of provider computers 30 may be utilized. In the present invention, each provider or shipping, transporting, carrying, and/or delivery entity, who or which utilizes the present invention, may have one or more provider computers 30 associated therewith.

Each of the client computer(s) 20 and each of the provider computer(s) 30 described herein can transmit information to each central processing computer 10 as well as receive information from each central processing computer 10. In addition, each client computer 20 can also transmit information to any provider computer 30 as well as receive information from any provider computer 30. In a similar manner, each provider computer 30 can transmit information to any client computer 20 as well as receive information from any client computer 20.

Each of the provider computers 30, the client computers 20, and/or the central processing computer(s) 10 can be wireless communication devices, and/or can be computers or other processing devices which can operate in a wireless communication environment, in a wired or line-connected environment, and/or in an combination and/or hybrid environment(s).

The central processing computer(s) 10, the client computer(s) 20, and/or the provider computer(s) 30 can communicate with one another, and/or be linked to one another, over a communication network and/or a wireless communication network. In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a respective web site, web sites, web page, and/or web pages, associated therewith. Any client computer(s) 20 and/or any provider computer(s) 30 can also have a respective web site, web sites, web page, and/or web pages, associated therewith.

Although the Internet and/or the World Wide Web is described as being a preferred communication system and/or medium utilized, the present invention, in all of the embodiments described herein, can also be utilized with any appropriate communication system(s) including, but not limited to, network communication systems, telephone communication systems, cellular communication systems, digital communication systems, personal communication systems, personal communication services (PCS) systems, satellite communication systems, third generation (3G) communication systems, broad band communication systems, low earth orbiting (LEO) satellite systems, and/or public switched telephone networks or systems.

In the preferred embodiment, each of the central processing computer(s) 10, the client computer(s) 20, and provider computer(s) 30, can transmit data and/or information using TCP/IP, as well as any other Internet and/or World Wide Web, protocols.

The client computer 20, in the preferred embodiment, can be linked directly or indirectly with a central processing computer 10. The provider computer 30, in the preferred embodiment, can also be linked directly or indirectly with a central processing computer 10. In any of the preferred embodiments described herein, any client computer(s) 20 and any provider computer(s) 30 can be linked directly or indirectly with one another so as to facilitate a direct or indirect bi-directional communication between any client computer(s) 20 and any provider computer(s) 30.

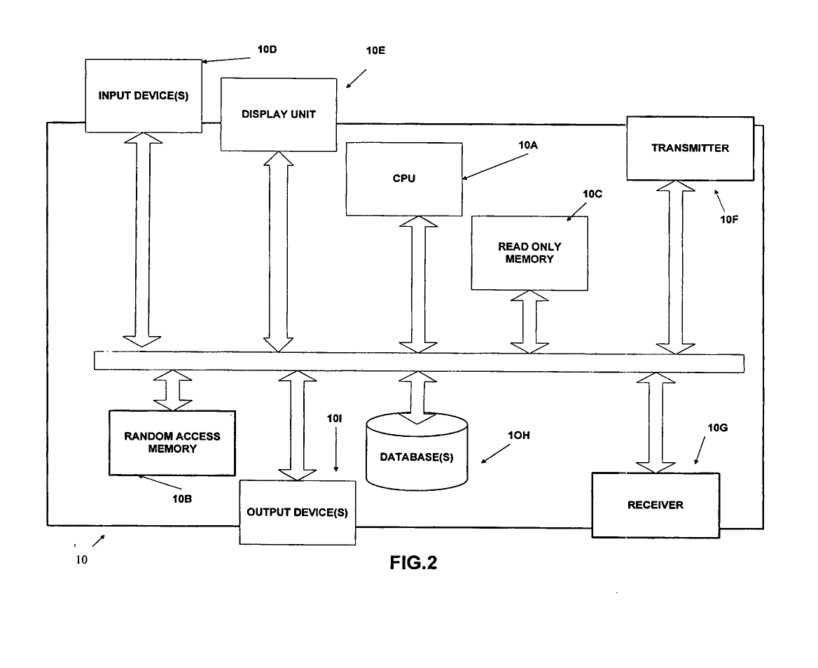

FIG. 2 illustrates the central processing computer 10, in block diagram form. The central processing computer 10, in the preferred embodiment, is a network computer or computer system which can be utilized as a central processing computer, an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, etc., if desired, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the client computer(s) 20 and/or provider computer(s) 30 which may be utilized in conjunction with the present invention. The central processing computer 10 also includes a receiver 10G, for receiving signals and/or data and/or information from any one or more of the client computer(s) 20 and/or provider computer(s) 30.

The central processing computer 10 also includes a database(s) 10H which contains data and/or information pertaining to any of the clients and providers who or which utilize the present invention. The database 10H contains information regarding the various providers of the respective shipping, transport, carrier, and/or delivery, individuals and/or service entities.

The database 10H can contain, for example, a providers name, address, phone number, facsimile number, e-mail address, licenses and/or permits held, training information, type of vehicle owned or utilized in the performance of the respective shipping, transport, carrier, and/or delivery, service, information regarding the type of vehicle belonging to or utilized by the provider or service entity, cargo capacity of the vehicle, types of loads which can be transportable by the vehicle, affiliations, employers, and/or associations, to which the provider has affiliations, employment, and/or associates, assignments, shipments, cargo and/or deliveries handled, charges for services, types of services provided, work experience, past jobs handled, conditions of employment and/or engagement, financial account information, insurance(s) carried by the provider or service entity, usual routes traveled, work schedules, references, vehicle cargo space availability, familiarity of delivery routes, special handling capabilities, terms or conditions of engagement, trends of past performance, past performance information, client reviews, licenses held, types of services provided (i.e. rush, non-rush, etc.), vehicle weight limitations, typical availability during a run, instantaneous cargo space availability, types of cargo carried (i.e. fragile, stackable, etc.), bonds, taxes paid status, verifiable billing address, verifiable living address, mileage traveled, conditions of engagement, discounts offered, incentives, scope and type of driver responsibility acceptance, vehicle service history, vehicle operating status, waiting time charges, hazardous material experience, shipping/delivery experience, brokers/agents associated therewith, and/or driver rating information, provider scheduling history, provider shipping/delivery history, typical times of deliveries, times for deliveries, and/or any other provider data and/or information which is needed and/or which can be desired for providing any of the herein-described services provided by the apparatus of the present invention.

The database 10H can also contain data and/or information regarding the various clients, including, but not limited to, name, address, telephone number, facsimile number, e-mail address, types of services purchased, types of services requested, fees paid for services utilized, conditions of engagement, insurance requirements, geographic location, location of pick-up, time of business operations, ratings of clients, offers to hire, down payments paid for services, payment methods, credit card information, letter of credit information, length of time in business, travel distance of deliveries, delivery destinations, delivery source locations, waiting time charges paid, special handling requirements, cargo weights, cargo size, pallet sizes, pallet weights, types of deliveries (i.e. rush, non-rush, etc.), route familiarity requirements, provider requirements, provider past history information, conditions, shipment and/or delivery time requirements, discounts/incentives sought, bond requirements, hazardous material requirements, payment history, credit rating, credit card information, debit card information, letter of credit information, identification requirements for engagement and/or pick-up, and/or any other client information which can be utilized and/or required in conjunction with use of the present invention.

The database 10H can also contain data and/or information regarding clients in various geographic regions, clients by service type, clients by credit ratings, clients by provider types, clients by conditions and/or terms of engagement, client locations, client geographic location, client location on a digitized map, client size, client goods or products, and/or client engagement terms. The database 10H also contains data and/or information regarding providers in various geographic regions, providers by service type, providers by credit ratings, providers by client types, providers by conditions and/or terms of engagement, provider routes and/or areas of travel or service, provider geographic location or position, including current locations, provider location on a digitized map, provider size, provider type, provider specialization, goods or products handled by providers, providers by goods or products and/or goods or products types, and/or provider engagement terms.

The database 10H can also contain electronic forms of contracts, agreements, and/or terms or conditions of engagement which can be utilized to allow any of the parties described herein to contract with one another. The database 10H can also contain electronic forms for effecting payments, letters of credit, performance bonds for providers, and/or any other legal documents, in electronic form and/or otherwise, for facilitating the formation of contracts, agreements, and/or engagements, bills of lading, shipment orders, invoices, packing slips, payment documents, and/or transfer documents.

The database 10H can also contain weigh station information, vehicle traffic laws and rules by locale and/or otherwise, vehicle inspection information, delivery vehicle routes, and/or traffic patterns by roadway or area.

The database 10H can also contain delivery schedules for providers, current real-time capacities, average available capacities, typical delivery routes/cargo, capacity availability, delivery and/or shipment requirements of clients, real-time delivery requirements, average delivery requirements, times of operation for clients, time(s) of operation for providers, and/or delivery or shipment pick-up times for clients or providers.

The database 10H can also contain data and/or information regarding distance to load pick-up for a provider or client, cargo space availability for a provider, concentration of providers in a given area or region, distance between loading and/or unloading points, provider's route familiarity, traffic patterns, weather conditions, climate conditions, road conditions, flight conditions, marine conditions, load priorities, special handling requirements, insurance types, insurance per load, past histories of successful/unsuccessful deliveries, past histories of timely and/or late deliveries, cargo sizes, standard pallet sizes, load/cargo weights and/or handling instructions, providers licenses and/or permits, provider performance ratings, independent providers, ratings of clients, information related to hazardous materials, points of delivery (PODs), delivery dates/deadlines, sizes/volumes/weights of skips, pallets, boxes, racks, ICC numbers, performance/payment bonds, roadworthiness of vehicles, information for verifying billing addresses, living address, provider information, client information, telephone numbers, facsimile numbers, mobile telephone numbers, two-way radio identification information, license/permit types and status held by providers, license/permit types and status held by and/or required by clients, mileage charts, type/mode of shipment, carriage and/or delivery (i.e. land, air, sea), paperless billing information, times of activities and/or operations, usage discounts and/or incentives, provider offered incentives, client offered incentives, provider acceptance responsibilities, condition of freight at pick-up and/or delivery, claims settlement information, times, and/or conditions, troubleshooting services, road repair and/or emergency services information, vehicle repair information, requirements by country, state, subdivision and/or locality, advance load booking information, priority load booking information, identification requirements at pick-up and delivery, guarantees for cash on delivery (COD) charges, times for acceptance of deliveries, appointment requirements and/or schedules, waiting time charges, pick-up charges, loading charges, unloading charges, global positioning information, position or location information, digitized map information, mapping data and/or information, bidding process information, workmen's compensation information, rating information for any of the providers and/or clients, including, but not limited to, reliability, length of service, experience for a given task or tasks, performance guarantees, insurance guarantees, digital signature information, bio-metric information, pricing schedules, recommended pricing information, contact information for and between provider, clients, and for and between providers and clients, instant messaging information, automated traffic updates and/or news, department of transportation check points, weighstations, and/or open and closing times and/or times of operation for weighstations.

The database 10H can also contain any other data and/or information for utilizing the apparatus and method of the present invention as described herein.

The database 10H can also contain data and/or information regarding client accounts for each provider as well as provider accounts for each client clients.

The data and/or information contained in the database 10H can also include information concerning events, occurrences, availability of a provider or providers and/or any other information of which a client or clients may want to be notified. The data and/or information contained in the database 10H can also include information concerning events, occurrences, availability of a client or clients assignments or jobs and/or any other information of which a provider or providers may want to be notified.

The database 10H may also contain any other information which may be relevant, pertinent, useful, and/or desired, for facilitating the operation of the apparatus and method of the present invention as described herein and/or as related thereto.

The database 10H, in the preferred embodiment, is a database which can include individual databases or collections of databases, with each database being designated to store any and all of the data and/or information described herein.

The data and/or information which is stored in the database 10H, or in the collection of databases, can be linked via relational database techniques, to the respective provider computers 30 and/or client computers 20 and/or via any appropriate database management techniques. The data and/or information, in the preferred embodiment, can be updated via inputs form the central processing computer 10 as well as via inputs from any of the client computers 20 and/or the provider computers 30 described herein, and/or from any other information source, at any time. Information updates can also be provided from other information sources via the communication network.

The database 10H, or collection of databases, can be updated by each of the respective and herein-described clients and/or providers, or by an administrator and/or operator of the central processing computer 10, and/or by any other third party, in real-time, and/or via dynamically linked database management techniques. The data and/or information stored in the database 10H can also be updated by external sources. The database 10H can also contain any and all information deemed necessary and/or desirable for providing all of the processing and/or services and/or functions described herein.

The database 10H can also contain any information needed for corresponding with any of the clients, providers, and/or other users, individuals, shippers, truckers, drivers, transporters, carriers, shipping provider, shipping providers, shipping service provider, shipping service providers, trucking service provider, trucking service providers, transportation service provider, transportation service providers, delivery service provider, delivery service providers, individual, individuals, provider or providers, and/or any brokers, agents, and/or representatives of same, such as their respective addresses, telephone numbers, e-mail addresses, pager number, and/or any other information for facilitating a communication with any of these respective parties.

The database 10H can also include provider-related data and/or information, and/or any other data and/or information needed and/or desired for performing any of the herein-described methods and features of the present invention.

With reference once again to FIG. 2, the central processing computer 10 also includes an output device 10I such as a printer, a modem, a fax/modem, or other output device, for providing data and/or information to the operator or user of the central processing computer 10 or to a third party or third party entity.

In the preferred embodiment, each of the client computer(s) 20 and the provider computer(s) 30, include the same, similar, or analogous, components and/or peripheral devices as described herein for the central processing computer 10. In this manner, any client computer(s) 20 or provider computer(s) 30, may be the same as, or be similar to, the central processing computer 10. In this regard, and depending upon the application and/or client and/or provider requirements, each of the client computers(s) 20 and/or each of the provider computer(s) 30 can have the same or similar components as the central processing computer 10.

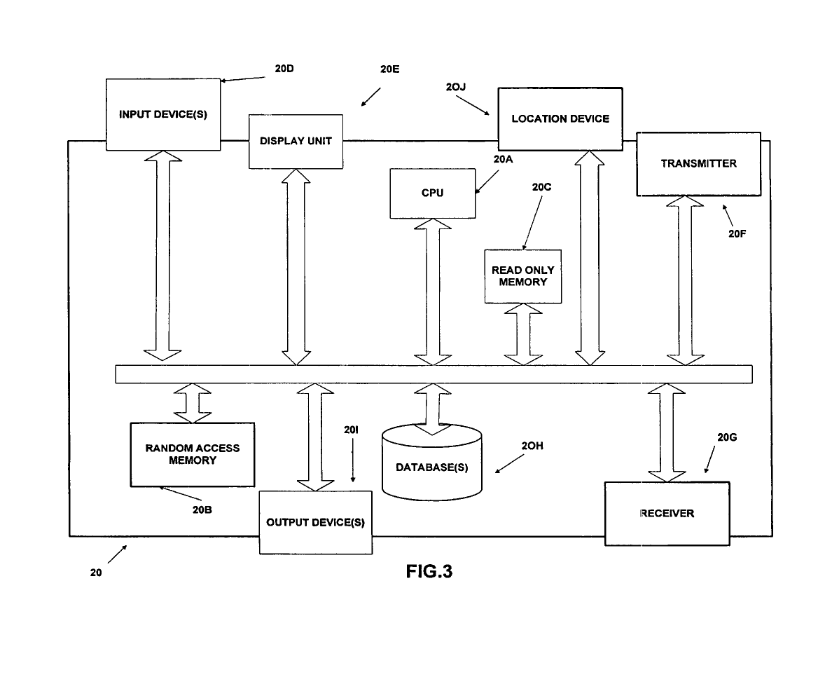

FIG. 3 illustrates the client computer 20, in block diagram form. The client computer 20, in the preferred embodiment, can be a computer, personal computer, computer system, or communication device, which can be utilized to access and/or to communicate with the central processing computer 10 and/or with any of the provider computers 30 described herein as well as any of the client computers 20 described herein. In the preferred embodiment, the client computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The client computer 20 also includes a random access memory device(s) 20B (RAM) and a read only memory device(s) 20C (ROM), each of which is connected to the CPU 20A, a user input device 20D, for entering data and/or commands into the client computer 20, which includes any one or more of a keyboard, a scanner, a user pointing device, such as, for example, a mouse, a touch pad, and/or an audio input device and/or a video input device, etc., if desired, which input device(s) are also connected to the CPU 20A. The client computer 20 also includes a display device 20E for displaying data and/or information to a user or operator.

The client computer 20 also includes a transmitter(s) 20F, for transmitting signals and/or data and/or information to any one or more of the central processing computer(s) 10 and to any of the provider computer (s) 30 and/or any of the other client computers 20. The client computer 20 also includes a receiver 20G, for receiving signals and/or data and/or information from any one or more of the central processing computer(s) 10 and/or the provider computer (s) 30 and/or any of the other client computers 20.

The client computer 20 also includes a database(s) 20H which can contain any and/or all of the data and/or information described herein with regards to the database 1 OH of the central processing computer 10. The database 20H can also contain data and/or information personal to any client or group of clients.

With reference once again to FIG. 3, the client computer 20 also includes an output device 20I such as a printer, a modem, a fax/modem, or other output device, for providing data and/or information to the operator or user of the client computer 20 or to a third party or third party entity.

The client computer 20 can also include a position and/or location device 20J which can be associated with the client or the client's facility, whether stationary or mobile and which can be utilized to determine and/or to ascertain client position or location. In any and/or all of the embodiments described herein, the position and/or location device 20J can utilize any suitable and/or appropriate positioning and/or locating devices, systems, and/or technologies, including but not limited to, global positioning system technologies, triangulation technologies, ESN triangulation technologies, wireless location system technologies, tracking technologies, time difference of arrival locating technologies, and/or any other positioning and/or locating devices, systems, and/or technologies.

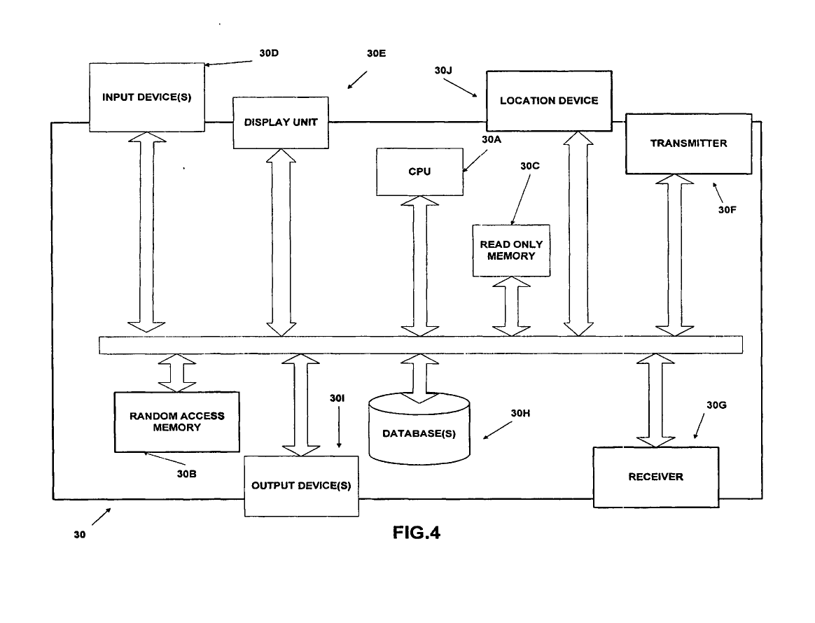

FIG. 4 illustrates the provider computer 30, in block diagram form. The provider computer 30, in the preferred embodiment, can be a computer, personal computer, computer system, or communication device, which can be utilized to access and/or to communicate with the central processing computer 10 and/or with any of the client computers 20 as well as with any of the other provider computers 30 described herein. In the preferred embodiment, the provider computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The provider computer 30 also includes a random access memory device(s) 30B (RAM) and a read only memory device(s) 30C (ROM), each of which is connected to the CPU 30A, a user input device 30D, for entering data and/or commands into the provider computer 30, which includes any one or more of a keyboard, a scanner, a user pointing device, such as, for example, a mouse, a touch pad, and/or an audio input device and/or a video input device, etc., if desired, which input device(s) are also connected to the CPU 30A. The provider computer 30 also includes a display device 30E for displaying data and/or information to a user or operator.

The provider computer 30 also includes a transmitter(s) 30F, for transmitting signals and/or data and/or information to any one or more of the central processing computer(s) 10 and to any of the client computer (s) 20 as well as any of the other provider computers 30. The provider computer 30 also includes a receiver 30G, for receiving signals and/or data and/or information from any one or more of the central processing computer(s) 10 and/or from any of the client computers 20 as well as any of the other provider computer (s) 30 described herein.

The provider computer 30 also includes a database(s) 30H which can contain any and/or all of the data and/or information described herein with regards to the database 10H of the central processing computer 10. The database 30H can also contain data and/or information which is personal to a provider or group of providers.

With reference once again to FIG. 4, the provider computer 30 also includes an output device 301 such as a printer, a modem, a fax/modem, or other output device, for providing data and/or information to the operator or user of the provider computer 30 or to a third party or third party entity.

The provider computer 30, in the preferred embodiment, is a computer or computer system which is utilized to access and/or to communicate with the central processing computer 10 and/or with any of the client computers 20. The provider computer(s) can also communicate with any of the other provider computers 30.

The provider computer 30 can also include a position and/or location device 30J which can be associated with the provider as well as with the provider's shipping, transport, or delivery, vehicle. In any and/or all of the embodiments described herein, the position and/or location device 30J can utilize any suitable and/or appropriate positioning and/or locating devices, systems, and/or technologies, including but not limited to, global positioning system technologies, triangulation technologies, wireless location system technologies, tracking technologies, time difference of arrival locating technologies, and/or any other positioning and/or locating devices, systems, and/or technologies.

The position and/or location device 30J can be connected with and/or linked to the provider computer 30 and/or to the CPU 30A. The position and/or location device 30J can provide vehicle position and/or location data and/or information for utilization in any of the embodiments described herein.

The databases 20H and 30H of the individual computer(s) 20 and the provider computer (s) 30, respectively, can contain any and/or all of the data and/or information which is stored and/or contained in the database 10H.

The database 10H, or collection of databases which form the database 10H, as well as any database 20H and/or 30H, and/or any other database(s) described herein, can be implemented by utilizing database software and/or spreadsheet software, such as, for example database software by Oracle®, Microsoft® Access®, and/or Microsoft® Excel®, or any other suitable database or spreadsheet software programs and/or systems.

The data and/or information described herein can be provided by any of the herein-described individuals and/or entities, and/or can be provided by an administrator or operator of the apparatus 100, and can be uploaded to, downloaded from, and/or can be stored and/or be resident on any of the central processing computer(s) 10, the client computer(s) 20, and/or the provider computer(s) 30.

In the preferred embodiment, wherein the apparatus 100 is utilized over the Internet and/or the World Wide Web, hyperlinks and/or other data and/or information links and/or linking methods and/or devices, can be utilized in order to provide an additional mechanism by which any of the client computers 20 and/or any of the provider computers 30, can access and/or can communicate with any other client computers 20, provider computers 30 and/or with the central processing computer 10. Any and/or all of the central processing computers 10, the client computers 20, and/or the provider computers 30, described herein, can also be linked to, and/or can access and/or communicate with, any external computer, computer system, and/or information source (not shown), including, but not limited to, news services, weather services, police departments, emergency medical services departments, road condition reporting services, traffic information services, and/or any other information which can be utilized by, and/or which can be useful to, any of the individuals and/or entities who or which utilize the present invention.

The data and/or information which is stored in the database 10H, as well as stored in any of the databases 20H and/or 30H, can be linked via any suitable data linking techniques such as, for example, hyperlinks, dynamically linked lists (DLLs), linked lists, and object links embedded (OLE's).

In any and all of the embodiments described herein, each of the client computers 20, the central processing computer(s) 10 and the provider computers 30 can communicate with one another via electronic submissions, electronic form submissions and/or transmissions, e-mail transmissions, facsimile transmissions, telephone messages, telephone calls, physical mail delivery, and/or via any other suitable communication technique, medium, or method.

The apparatus and method of the present invention can be utilized in order to provide numerous services to or for any of the herein-described clients and/or providers.

In any and/or all of the embodiments described herein, any of the providers and/or clients described herein as utilizing the apparatus and method of the present invention can obtain data and/or information from the present invention in real-time and/or otherwise. In this manner, any data transmissions and/or any communications which can take place between any of the parties described herein and/or any of the central processing computers, the client computers and/or communication devices, and/or the provider computers and/or communication devices, described herein, can take place in real-time and/or otherwise.

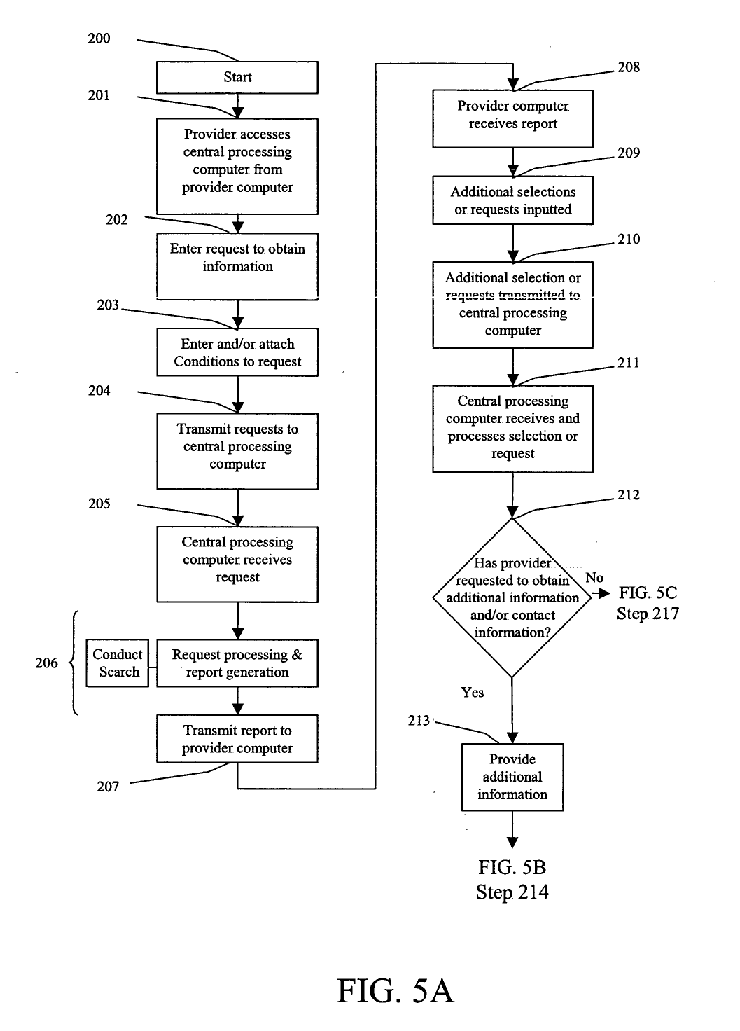

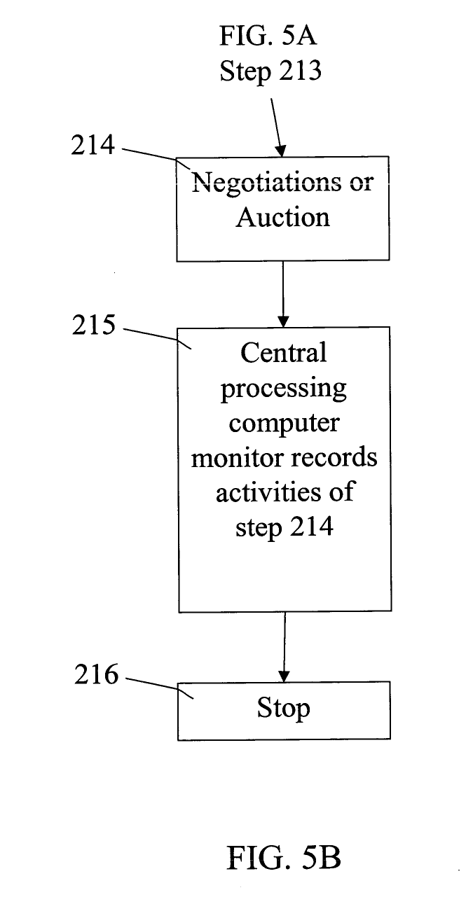

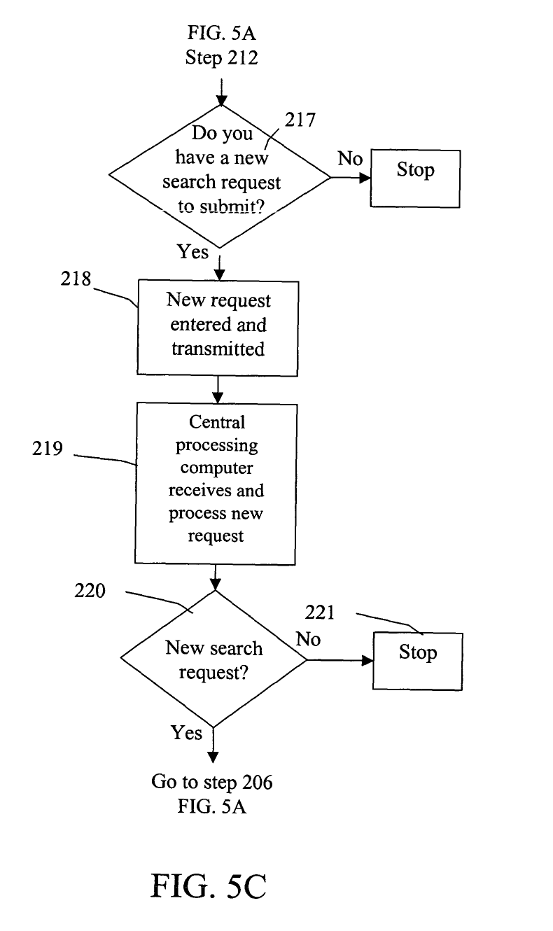

In a preferred embodiment, the apparatus and method of the present invention can be utilized by providers in order to search for and/or to locate shipping or delivery assignments or jobs. FIGS. 5A, 5B and 5C illustrate a preferred embodiment method for utilizing the apparatus and method of the present invention in order to assist a provider in identifying and/or in finding an assignment or job.

The embodiment of FIGS. 5A, 5B and 5C can be utilized by any provider or providers described herein. The embodiment of FIGS. 5A, 5B and 5C will, as an example, be described herein as being utilized by a truck driver or trucker, although it is to be understood that any and/or all of the embodiments of the present invention and/or the methods of utilizing same can be utilized by any of the providers described herein.

With reference to FIGS. 5A, 5B and 5C, the operation of the apparatus 100 commences at step 200. At step 201, the provider, truck driver, or trucker, who has or who will have the space capacity to pick-up and deliver a shipment can access the central processing computer 10. At step 202, the provider or truck driver can enter a request to obtain information regarding any available shipments which are available to be made and/or which can be made. The shipment information can be posted by any of the herein-described clients. For example, a manufacturer(s) can post a request to find a provider, truck driver, or trucker, to make a shipment of goods from one location to another. A detailed description, which can include shipment size, pick-up location, destination, weight, and the price(s) which the client may want to pay for the shipment, can be included with the listing. The provider's or truck driver's request can include information regarding his or her available cargo space, location, destination, route, available shipment size, weight, and/or capacity, and/or price or charge for the shipment.

At step 203, the provider, truck driver, or trucker, can also enter and/or attach conditions to his or her request. These conditions can include any condition or terms of engagement typically utilized in the shipping or delivery business. At step 204, the truck driver's request, information, and/or conditions, can be transmitted from the provider computer 30 to the central processing computer 10.

At step 205, the central processing computer 10 will receive the request, information, and/or conditions. At step 206, the central processing computer 10 will process the request along with any other information and/or conditions. In the preferred embodiment, the database 10H of the central processing computer 10 will include a listing of client assignments or jobs which are available. Clients may at any time access the central processing computer 10 and enter their respective assignments and/or jobs and/or any of the other herein-described information into the central processing computer 10 which will store same in the database 10H. The stored information can be utilized in conducting the search or searches at step 206. At step 206, the central processing computer 10 will generate a report of any matches for the truck driver's request. At step 207, the report will be transmitted to the provider computer 30.

At step 208, the provider or truck driver can receive the report and review same. The provider or truck driver can then, at step 209, make any desired selection(s) and/or request for additional information and/or contact information in order to pursue any of the opportunities which are provided in the report. At step 210, the provider's or truck driver's request or selection will be transmitted to the central processing computer 10. In another preferred embodiment, the report may already contain any and/or all of the additional information and/or contact information needed for the provider to contact the client(s) and/or to make a completely informed decision regarding an opportunity, a client(s), an assignment(s), and/or a job(s).

At step 211, the central processing computer 10 will receive and process the provider's or truck driver's selection or request to receive additional information and/or contact information for or regarding any of the opportunities, clients, assignments, and/or jobs, which are contained in the report. At step 212, the central processing computer 10 will determine whether the provider has requested to obtain additional information and/or contact information regarding any of the available and/or identified assignments or jobs.

If, at step 212, it is determined that the provider has requested additional information and/or contact information regarding any of the opportunities, clients, assignments and/or jobs, then the central processing computer 10 will proceed to step 213 and provide the provider with the additional information and/or the contact information. The additional information and/or the contact information can include the information needed for the provider to contact a respective client(s). Thereafter, the parties may, at step 214, enter into negotiations and/or enter into a shipment and/or delivery agreement and/or any other agreement and/or arrangements.

In another preferred embodiment, at step 214, the parties can participate in an on-going auction and/or in a bidding process. The truck driver may bid on the assignment(s) or job(s). The client(s) can bid for the truck driver's services. The truck driver can auction off his or her services. The client can also auction off its assignment(s) or job(s). In any of the embodiments described herein, the parties can be directed into a virtual auction facility which can include other clients and/or truck drivers. In this manner, the apparatus and method of the present invention can facilitate an auction and/or a bidding platform for the services described herein to or for any of the parties described herein.

At step 215, the central processing computer 10 can monitor and/or record any of the actions of any of the parties along with recording any information regarding any deals reached between the parties. This can be accomplished by receiving information from any of the parties, by monitoring any negotiations, auctions, and/or bidding processes, in real-time and/or otherwise, by transmitting a status update request to a party or to the parties, and/or by any other appropriate means or mechanism. The central processing computer 10 can also monitor negotiations and/or deals by having all of the offers, counteroffers and/or acceptances being directed to, and/or passed through, the central processing computer 10. Thereafter, the operation of the apparatus 100 will cease at step 216.

If, at step 312, it is determined that no additional information and/or contact information had been requested regarding any opportunities, clients, assignments, and/or jobs, the central processing computer 10 will proceed to step 217 and transmit a message inviting the provider to enter a new search if the provider desires. At step 218, the provider can then enter a new search. At step 219, the central processing computer 10 will receive and process the provider's request or search. At step 220, the central processing computer 10 will determine if a new search request has been entered. If, at step 220, it is determined that a new search request has been entered or that a new search request has been made, then the processing of the apparatus 100 will proceed to step 202 and the above-described process will be repeated. If, however, it is determined that the provider did not enter a new request or search, the operation of the apparatus 100 will cease at step 221.

In another preferred embodiment, the apparatus and method of the present invention can be utilized by a broker, an agent, and/or a representative, of a provider or group of providers, and/or by any other third party, in order to identify shipping or delivery assignments or jobs, for any of the providers or truck drivers described herein.

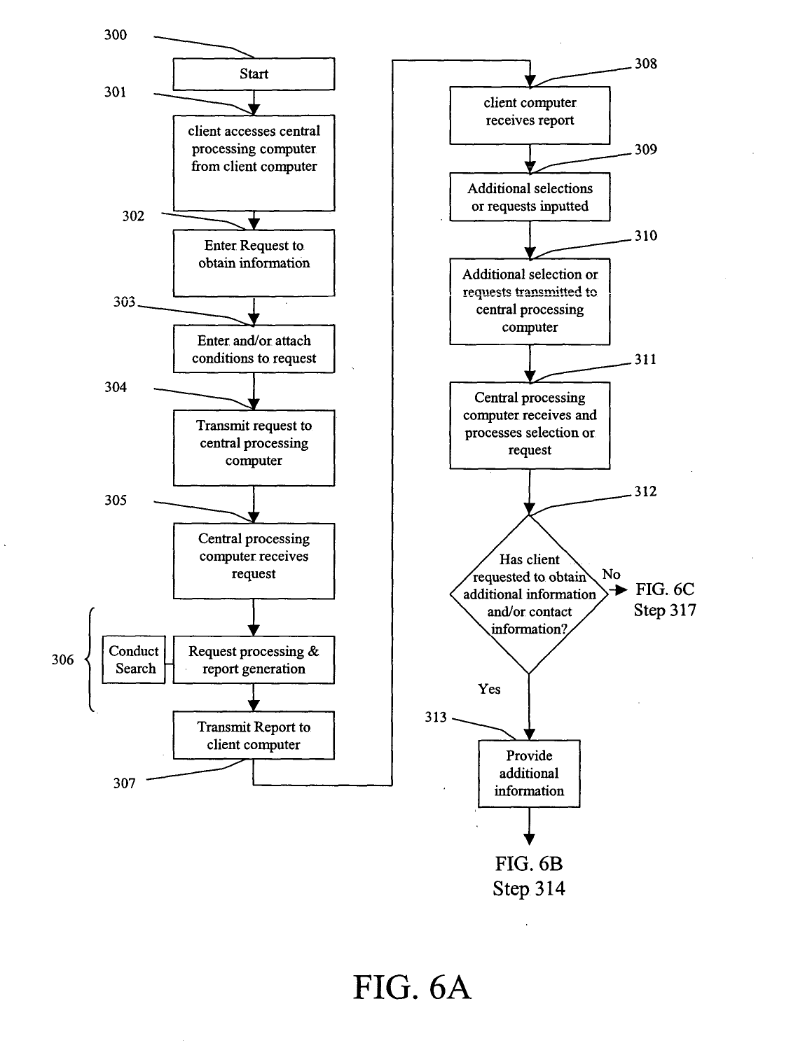

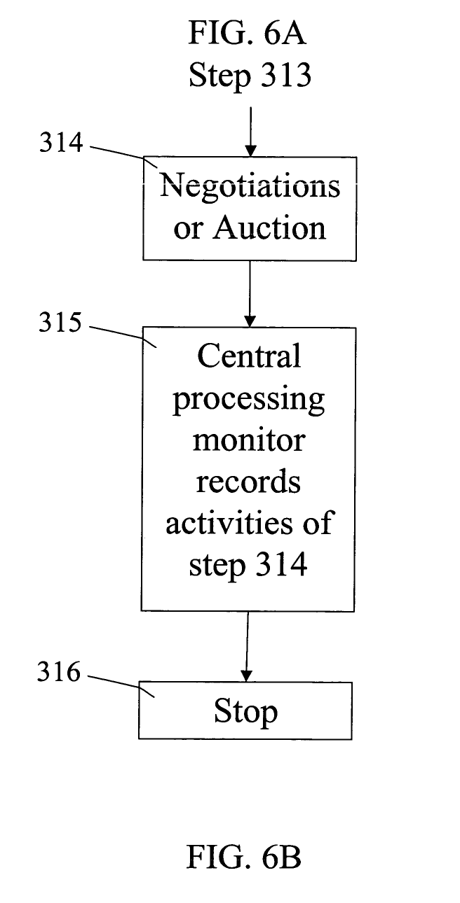

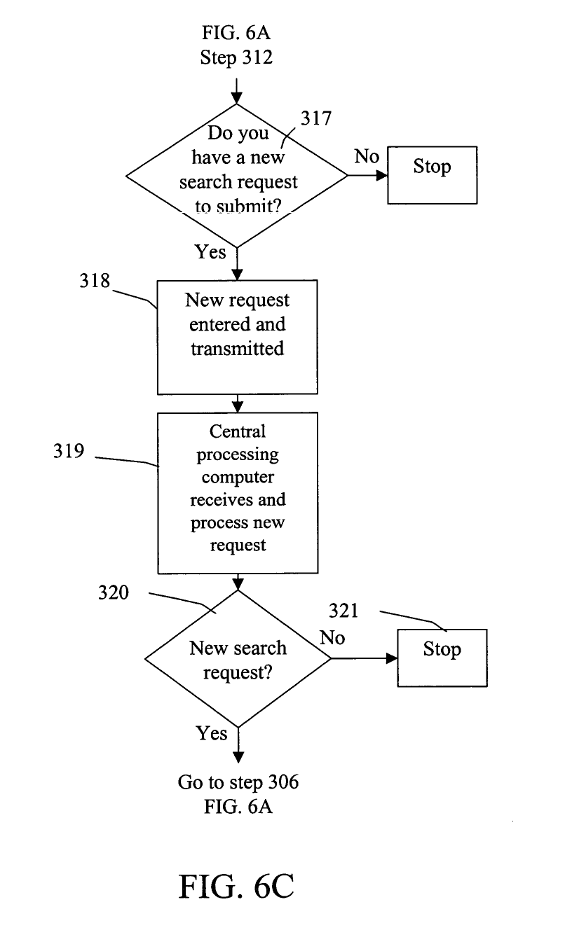

In another preferred embodiment, the apparatus and method of the present invention can be utilized by clients in order to search for and/or to locate a shipping or delivery provider who or which may be able to fulfill their shipping or delivery needs. FIGS. 6A, 6B and 6C illustrate a preferred embodiment method for utilizing the apparatus and method of the present invention in order to assist a client in identifying and/or finding a shipping or delivery service provider.

The embodiment of FIGS. 6A, 6B and 6C will, as an example, be described herein as being utilized by a client to find a provider, a truck driver, or a trucker, to provide a shipping or delivery service and/or to fill the shipping or delivery needs of the client. It is, however, to be understood that any and/or all of the embodiments of the present invention and/or the methods of utilizing same can be utilized by any of the clients described herein to locate and/or engage any of the providers described herein. With reference to FIGS. 6A, 6B and 6C, the operation of the apparatus 100 commences at step 300. At step 301, the client who has or who will have a shipment or delivery to make can access the central processing computer 10. At step 302, the client can enter a request to obtain information regarding any available providers or truck drivers who or which are or may be available to provide a shipping of delivery service for the client.

Provider information and/or provider availability information can be posted by any of the herein-described providers of truck drivers. For example, a provider or truck driver can post a request to find a client who has a shipment or delivery which has to be made or effected. A detailed description, which can include available shipment size(s), pick-up location, destination, weight, and the price(s) for providing the service which the provider may want to be paid, can be included with the listing. The client's request can include information regarding cargo space or size, location, destination, route, shipment weight, and/or desired price which the client desires to pay for the shipment or delivery.

At step 303, the client can enter and/or attach conditions to his or her request. These conditions can include any condition or terms of engagement typically utilized in the shipping or delivery business or industry. At step 304, the client's request, information, and/or conditions, can be transmitted from the client computer 20 to the central processing computer 10. At step 305, the central processing computer 10 will receive the request, information, and/or conditions. At step 306, the central processing computer 10 will process the client's request along with any other information and/or conditions in conjunction with the provider postings.

In the preferred embodiment, the database 10H of the central processing computer 10 will include a listing of providers who or which are available to provide any of the various services described herein. Providers or truck drivers may at any time access the central processing computer 10 and enter their respective services and/or their availability and/or any other of the herein-described information into the central processing computer 10 which will store same. The stored information can be utilized in the search which is performed at step 306. At step 306, the central processing computer 10 will generate a report of any matches for the client's request. At step 307, the report will be transmitted to the client computer 20.

At step 308, the client can receive the report and review same. The client can then, at step 309, make any desired selection(s) in order to pursue any of the opportunities to which he or she has become aware. In another preferred embodiment, the report may already contain any and/or all of the additional information and/or contact information needed for the client to contact the provider(s) and/or to make a completely informed decision regarding a provider or providers. At step 310, the client's request or selection will be transmitted to the central processing computer 10.

At step 311, the central processing computer 10 will receive and process the client's selection or request. At step 312, the central processing computer 10 will determine whether the client has requested to obtain additional information and/or contact information regarding any of the available and/or identified providers.

If, at step 312, it is determined that the client has requested additional information and/or contact information regarding any of the providers, then the central processing computer 10 will proceed to step 313 and provide the client with the additional information and/or the contact information. The additional information and/or the contact information can include the information needed for the client to contact a respective provider(s) or truck driver(s). Thereafter, the parties may, at step 314, enter into negotiations and/or enter into a shipment and/or delivery agreement and/or any other agreement and/or arrangements.

In another preferred embodiment, at step 314, the parties can participate in an on-going auction and/or in a bidding process. The client may auction off the assignment(s) or job(s). The provider may bid on the assignment(s) or job(s). The provider or truck driver can bid for the client's assignment(s) or job(s). The provider or truck driver can auction off his or her services. In any of the embodiments described herein, the parties can be directed into a virtual auction facility which can include other clients and/or providers or truck drivers. In this manner, the apparatus and method of the present invention can facilitate an auction and/or a bidding platform for the services described herein to or for any of the parties described herein.

At step 315, the central processing computer 10 can monitor and/or record any of the actions of any of the parties along with recording any information regarding any deals reached between the parties. This can be accomplished by receiving information from any of the parties, by monitoring any negotiations, auctions, and/or bidding processes, in real-time and/or otherwise, by transmitting a status update request to a party or to the parties, and/or by any other appropriate means or mechanism. The central processing computer 10 can also monitor negotiations and/or deals by having all of the offers, counteroffers and/or acceptances, being directed to, and/or passed through, the central processing computer 10. Thereafter, the operation of the apparatus 100 will cease at step 316.

If, at step 312, it is determined that no additional information and/or contact information has been requested regarding any provider(s), the central processing computer 10 will proceed to step 317 and transmit a message inviting the client to enter a new search if the client desires. At step 318, the client can then enter a new search. At step 319, the central processing computer 10 will receive and process the client's request or search. At step 320, the central processing computer 10 will determine if a new search request has been entered. If, at step 320, it is determined that a new search request has been entered or that a new search request has been made, then the processing of the apparatus 100 will proceed to step 302 and the above-described process will be repeated. If, however, it is determined that the client did not enter a new request or search, the operation of the apparatus 100 will cease at step 321.

In another preferred embodiment, the apparatus and method of the present invention can be utilized by a broker, an agent, and/or a representative, of a client or group of clients, and/or by any other third party, in order to identify a provider(s) of any of the herein-described shipping or delivery services, for any of the clients described herein.

In another preferred embodiment, the present invention can be utilized in order to provide an on-line auction environment. The auction can be for auctioning off services of any of the various providers described herein, and/or for auctioning off the assignments and/or jobs which can be offered by any of the clients described herein. The auction can also be for bidding for the services of any of the providers described herein and/or for bidding for assignments and/or jobs offered by any of the clients described herein. The auction or auctions facilitated by the apparatus and method of the present invention can also be any combination and/or a hybrid of any of the various auctions described herein.

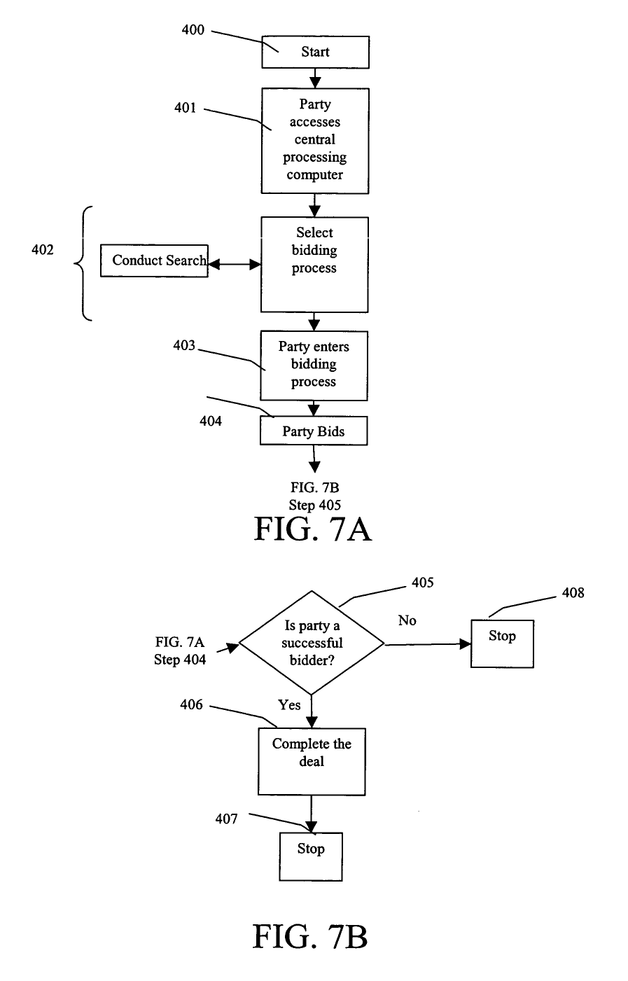

FIGS. 7A and 7B illustrate a preferred embodiment method for utilizing the apparatus and method of the present invention in an auction environment. In the preferred embodiment of FIGS. 7A and 7B, the auction or auctions can be announced, to any of the interested and/or respective parties or individuals, by e-mail transmission, electronic transmission, telephone transmission, facsimile transmission, beeper or pager message, and/or via any other notification means or method.

It is envisioned that any of the parties, clients, and/or providers described herein can register with the apparatus 100, with said registration information being stored in the database 10H of the central processing computer 10. In another preferred embodiment, a respective party, client and/or provider can simply access the central processing computer 10 and/or the web site associated with and/or corresponding to same, and receive information regarding, and/or a notification of, the auction and/or the auction of interest to the respective party, client and/or provider.

With reference to FIGS. 7A and 7B, the operation of the apparatus 100 commences at step 400. At step 401, the parties desiring to participate in the auction or the bidding process can access the central processing computer 10. A respective party, a client, and/or a provider, can enter the auction at the start of same and/or at any time while the auction is in process. Information regarding matters being auctioned, matters being bid on, and/or matters which are to be auctioned and/or bid on, can be provided upon request and/or can be transmitted to the respective party or parties at any time and/or on an on-going or continuous basis. In another preferred embodiment, any of the herein-described information can be provided on a streaming basis or on an information feed basis.

At step 402, the party, client, and/or provider, can select the auction of bidding process which he, she, or it, wishes to participate in. In another alternate embodiment, the respective party, client, and/or provider, can search for the auction or bidding process in which he, she, or it, may desire to learn about and/or participate in. This search can be analogous to the search performed at steps 206 and 306 in the embodiments of FIGS. 5A, 5B and SC and FIGS. 6A, 6B and 6C, respectively.

At step 403, the respective part, client, and/or provider, can enter the action or bidding process. At step 404, the respective party, client, and/or provider, can participate in the auction and/or bidding process. At step 404, a determination is made as to whether the party, client, and/or provider has been a successful party or the winning party. For example, a party, client, and/or provider, may be a successful party or the winning party by being a respective highest bidder in the case of a provider's service(s) being sold (i.e. a provider obtaining a highest possible price to provide any of his or her services), or a lowest bidder in the case of an assignment or a job being sold (i.e. a client obtaining a lowest price from a provider to fulfill a shipment or delivery assignment for the client). In any of the auction and/or bidding processes described herein, non-monetary factors or conditions can also be included in the auction or bidding process.

If, at step 405, it is determined that the party has been successful, as a winner or otherwise, of an auction or bidding process, the operation of the apparatus 100 will proceed to step 406 so that any respective or associated deal can be completed or consummated. Thereafter, the operation of the apparatus 100 will cease at step 407.

If, at step 405, it is determined that the party has been unsuccessful in the auction or bidding process, the operation of the apparatus 100 will cease at step 408.

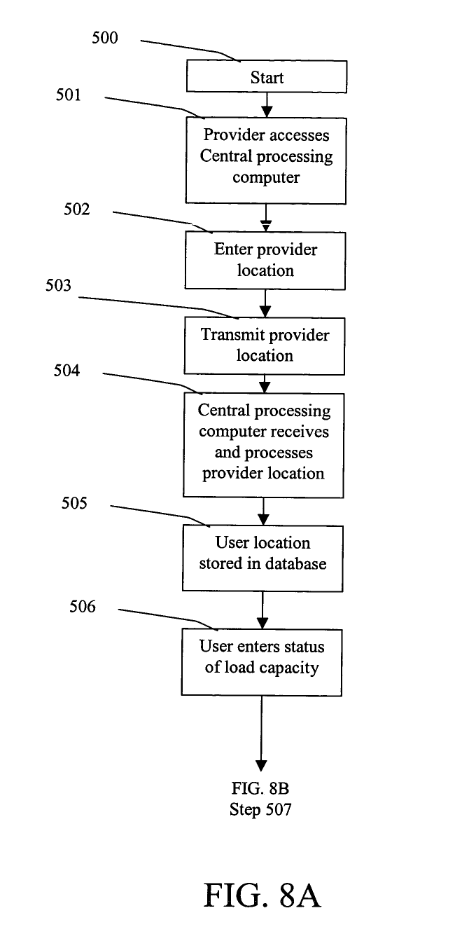

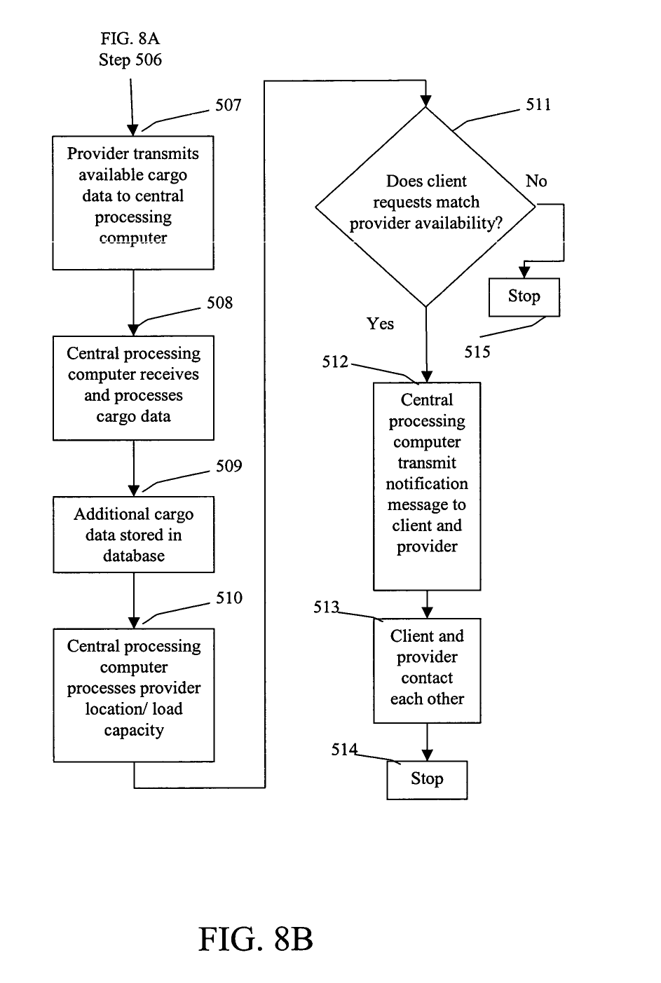

In another preferred embodiment, the apparatus and method of the present invention can be utilized in order to allow a provider of shipping or delivery services to provide updates of his, her, or its, location and/or available cargo capacity. In this manner, the provider can provide notice to any potential clients of his, her, or its, location and capacity to pick-up a load for shipment and/or for delivery. FIGS. 8A and 8B illustrate another preferred embodiment method for utilizing the apparatus and method of the present invention.

With reference to FIGS. 8A and 8B, the operation of the apparatus 100 commences at step 500. At step 501, the provider or truck driver can access the central processing computer 10 via the provider computer 30. At step 502, the provider or truck driver can enter his or her location data and/or transmit same to the central processing computer 10. The location data can be transmitted in the form of a transmission from the position and/or location device 30J or can be data which is entered manually into the provider computer 30. In this manner, the provider's or truck driver's location can be monitored by the central processing computer 10.

In another preferred embodiment, the provider, truck driver, or other authorized individual, can request an automatic positioning and/or location update of the provider's or the truck driver's vehicle. In this embodiment, the provider computer 30 and/or the position and/or location device 30J can be programmed to transmit vehicle position and/or location data to the central processing computer 10 at regular intervals, at periodic intervals, and/or at random intervals, and/or upon the occurrence of certain events (i.e. a stop, a delivery, ect.).

In another preferred embodiment, the central processing computer 10 can also be programmed to transmit a location status message to the provider computer 30 and/or to the position and/or location device 30J and obtain vehicle positioning and/or location data from either the provider computer 30 and/or the position and/or location device 30J.

At step 503, the position or location data can be transmitted to the central processing computer 10. At step 504, the central processing computer 10 will receive and process the provider position or location information. At step 505, the vehicle position or location data can be stored in the database 10H.

At step 506, the provider or truck driver can enter the status of his or her available capacity to pick-up a load for shipment and/or for delivery. The provider or truck driver can enter the available space information manually. In another preferred embodiment, the provider or truck driver can list his or her load carrying status at the start of a trip and, thereafter, report all unloadings or deliveries and/or loadings. In this manner, the central processing computer 10 and/or the provider computer 30 can store this information which can then be made available and/or can be utilized by any of the parties described herein as utilizing the present invention. For example, in the embodiment where the central processing computer 10 and/or the provider computer 30 can keep track of available cargo space in the vehicle, a client identifying the vehicle as being in its vicinity and with ample capacity to pick-up its load, can utilize the present invention to identify and engage a provider or truck driver.

The information regarding the amount of cargo which is loaded and/or unloaded can be entered manually or automatically by the provider or truck driver with or upon each instance of same and/or can be monitored, either manually and/or automatically, by utilizing a scanner device, a bar code scanner, and/or any other monitoring equipment which can monitor cargo or shipments as they are loaded and/or unloaded from the vehicle. For example, bar code labels for a particular size, weight, or type, or cargo, goods, or products, can be standardized so as to facilitate accurate record keeping of cargo when taken in view of the vehicle's load carrying capacity.

Scanning devices and/or scanners, having sufficient reaching capabilities and/or long range scanning capabilities, can also be utilized in conjunction with the present invention in order to detect and/or identify a load as it is being loaded and/or unloaded from the vehicle.

At step 507, the available cargo capacity data is transmitted to the central processing computer 10. At step 508, the available cargo capacity information is received by the central processing computer 10 and processed. At step 509, the available cargo capacity data is stored in the database 10H of the central processing computer 10.

At step 510, the central processing computer 10 can process the position or location data and/or information, and the available cargo capacity data and/or information in conjunction with requests for shipment or delivery services which can be stored in the database 10H. The requests for shipment or delivery services can be entered by any of the herein-described clients who or which utilize the present invention. The request for shipment or delivery services can be posted by any client at any time by the client transmitting same from the client computer 20 or other communication device, and/or by submitting such request manually and/or verbally such as over the telephone with an operator associated with the central processing computer 10.

Thereafter, the client request can be transmitted to the central processing computer 10 and stored in the database 10H. The client request will then be available for processing in conjunction with the provider's or truck driver's position or location data and/or the vehicle's available cargo capacity.

At step 510, the central processing computer 10 will process the information in order to identify any potential matches of client requests to provider or truck driver availability. At step 511, a determination is made regarding whether any matches have been identified. If, at step 511, it is determined that matches of client requests to provider or truck driver availability have been found, the operation of the apparatus 100 will proceed to step 512 and the central processing computer 10 will transmit a notification message, such as an e-mail message, a telephone call, a facsimile transmission, etc., to the provider or truck driver and to the client.

The notification message can contain, in the preferred embodiment, contact information regarding the respective parties. Thereafter, at step 513, the provider or truck driver and the client can contact one another in order to see if a deal can be entered into. Thereafter, the operation of the apparatus 100 will cease at step 514.

If, at step 511, no matches have been identified, the operation of the apparatus 100 will cease at step 515.

In another preferred embodiment, the apparatus 100 and/or the central processing computer 10 can monitor information regarding the shipping or delivery needs of any number of clients against location or position updates and available cargo capacity for any number of providers, either manually and/or automatically, in order to provide a dynamic clearinghouse for matching clients needs with available providers.

In another preferred embodiment, the apparatus and method of the present invention can be utilized by a broker, an agent, and/or a representative, of a client or group of clients, and/or by any other third party, in order to utilize the above-described embodiment on behalf of any of the respective parties.

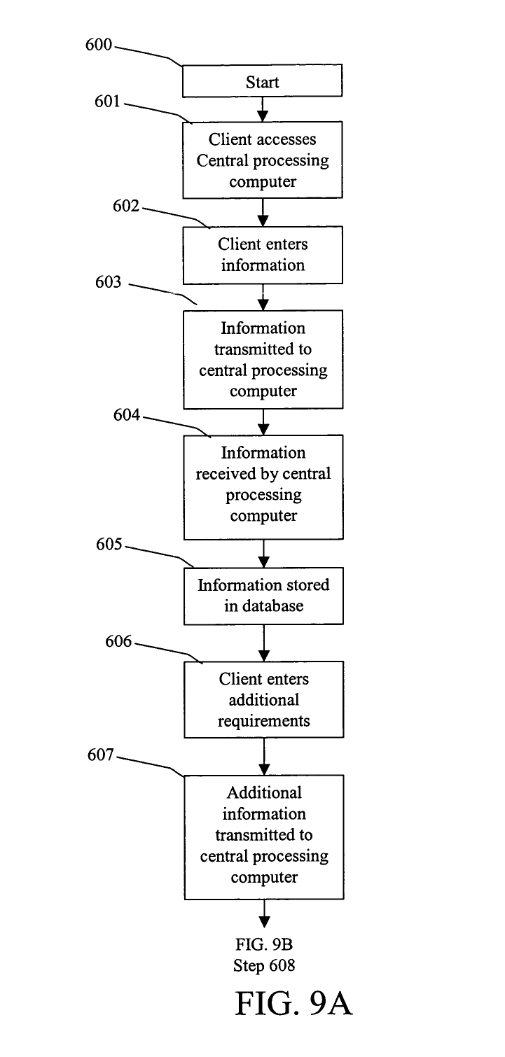

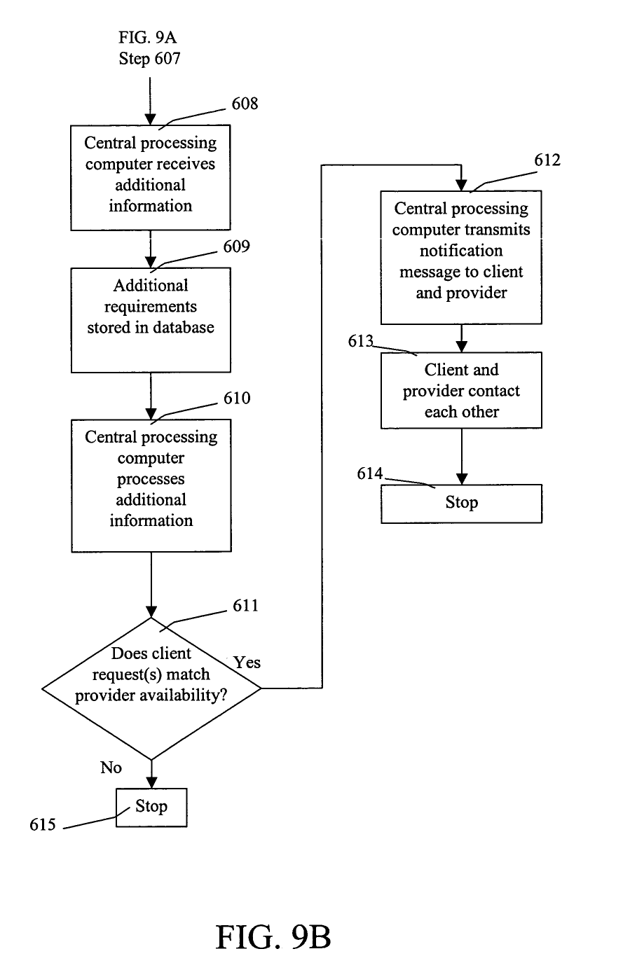

In another preferred embodiment, the apparatus and method of the present invention can be utilized in order to allow a client of shipping or delivery services to post his, her, or its, location and shipment or delivery needs. In this manner, the client can provide notice to any potential providers or truck drivers of his, her, or its, location and requirements and/or needs for a shipment or delivery. FIGS. 9A and 9B illustrate another preferred embodiment method for utilizing the apparatus and method of the present invention.

With reference to FIGS. 9A and 9B, the operation of the apparatus 100 commences at step 600. At step 601, the client can access the central processing computer 10 via the client computer 20 and enter any identification information. At step 602, the client can enter his, her, or its, location data and/or information. At step 603, the location data and/or information is transmitted to the central processing computer 10. The location data can be transmitted in the form of a transmission from the position and/or location device 20J associated with the client computer 20 or can be data which is entered manually into the client computer 20. Client location data and/or information can also be pre-stored at the time of a client's initial use of the present invention and/or at the time of registration with the central processing computer 10 and/or other authorized service utilizing same.

At step 603, the client location data and/or information, if needed, is transmitted to the central processing computer 10. At step 604, the client position or location data and/or information is received at the central processing computer 10. At step 605, the client position or location data and/or information can be stored in the database 10H.

At step 606, the client can enter his, her, or its, shipment or delivery requirements and/or requests. The client can enter specific requirements, load characteristics, and/or any other information and/or conditions manually and/or automatically. In another preferred embodiment, the client can posts its shipment or delivery requirements at the start of a pre-specified period and, thereafter, report all shipments or deliveries made to date. In this manner, the central processing computer 10 and/or the client computer 20 can store this information which can then be made available and/or can be utilized by any of the parties described herein as utilizing the present invention. For example, in the embodiment where the central processing computer 10 and/or the client computer 20 can keep track of shipment or delivery requirements for a client, a provider identifying the client as being in its vicinity can utilize the present invention to identify and engage a client.

The information regarding the shipment or delivery requirements of the client can be entered manually by the client or its representative and/or by other providers as they provide shipment or delivery services for the client. Shipment or delivery information can also be monitored by utilizing a scanner device, a bar code scanner, and/or any other monitoring equipment which can monitor cargo or shipments as they are loaded and/or unloaded from the provider's vehicle. For example, bar code labels for a particular size, weight, or type, or cargo, goods, or products, can be standardized so as to facilitate accurate record keeping of cargo when taken from the client's facility or otherwise.

At step 607, the client's shipment or delivery requirements or information is transmitted to the central processing computer 10. At step 608, the client's shipment or delivery information is received at the central processing computer 10. At step 609, the client's shipment or delivery requirements or information is stored in the database 10H of the central processing computer 10.

At step 610, the central processing computer 10 can process the client's requirements for shipment or delivery against provider or truck driver availability information which can be stored in the database 10H. The provider or truck driver availability information can include any of the information described herein for determining a provider's or a truck driver's availability and ability to handle an assignment(s) or job(s). The provider or truck driver availability information can be entered by any of the herein-described providers who or which utilize the present invention.

The provider availability information can be posted by any provider(s) at any time by the provider(s) transmitting same from the respective provider computer(s) 30 or other communication device(s), and/or by submitting such request manually such as over the telephone with an operator associated with the central processing computer 10. Thereafter, the provider posting can be transmitted to the central processing computer 10 and can be stored in the database 10H. The provider posting(s) will then be available for processing in conjunction with the client's requirements for shipments or deliveries. Provider availability information can also include position or location data and/or information for the provider.

At step 608, the central processing computer 10 will process the information in order to identify any potential matches of client requirements with provider availability. At step 611, a determination is made regarding whether any matches have been identified. If, at step 611, it is determined that matches of client requirements to provider or truck driver availability have been found, the operation of the apparatus 100 will proceed to step 612 and the central processing computer 10 will generate and/or transmit a notification message, such as an e-mail message, a telephone call, a facsimile transmission, etc. to the client and to the provider or truck driver. The notification message can contain information regarding clients who or which have shipment or delivery requirements which the provider(s) may be able to fulfill.

The notification message can contain, in the preferred embodiment, contact information regarding the respective parties. Thereafter, at step 613, the client and the provider or truck driver can contact one another in order to see if a deal can be entered into. Thereafter, the operation of the apparatus 100 will cause at step 614.

If, at step 611, no matches have been identified, the operation of the apparatus 100 will cease at step 615.

In another preferred embodiment, the apparatus 100 and/or the central processing computer 10 can automatically monitor information regarding the shipment or delivery requirements of any number of clients against the availability of any number of providers in order to provide a dynamic clearinghouse for matching clients needs with available providers.

In another preferred embodiment, the apparatus and method of the present invention can be utilized by a broker, an agent, and/or a representative, of a client or group of clients, and/or by any other third party, in order to utilize the above-described embodiment on behalf of any of the respective parties.

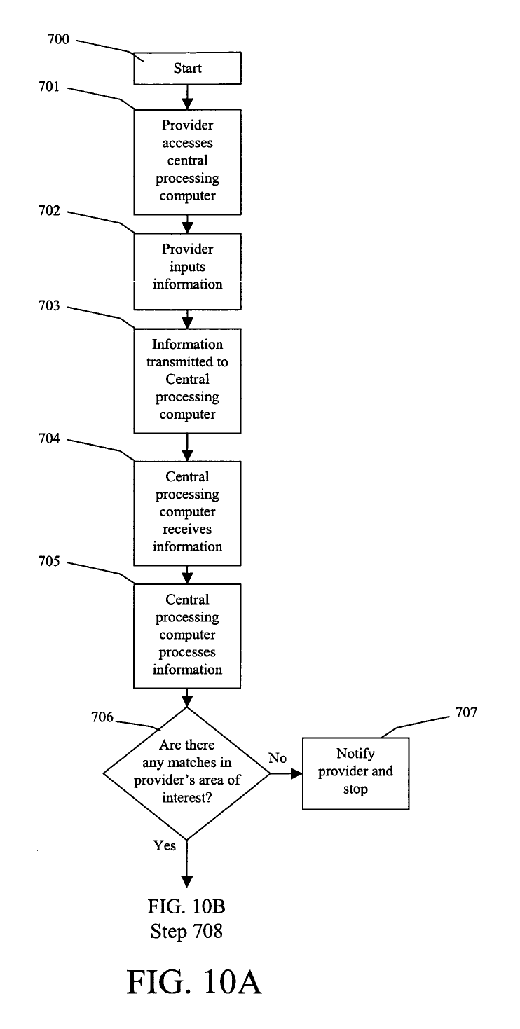

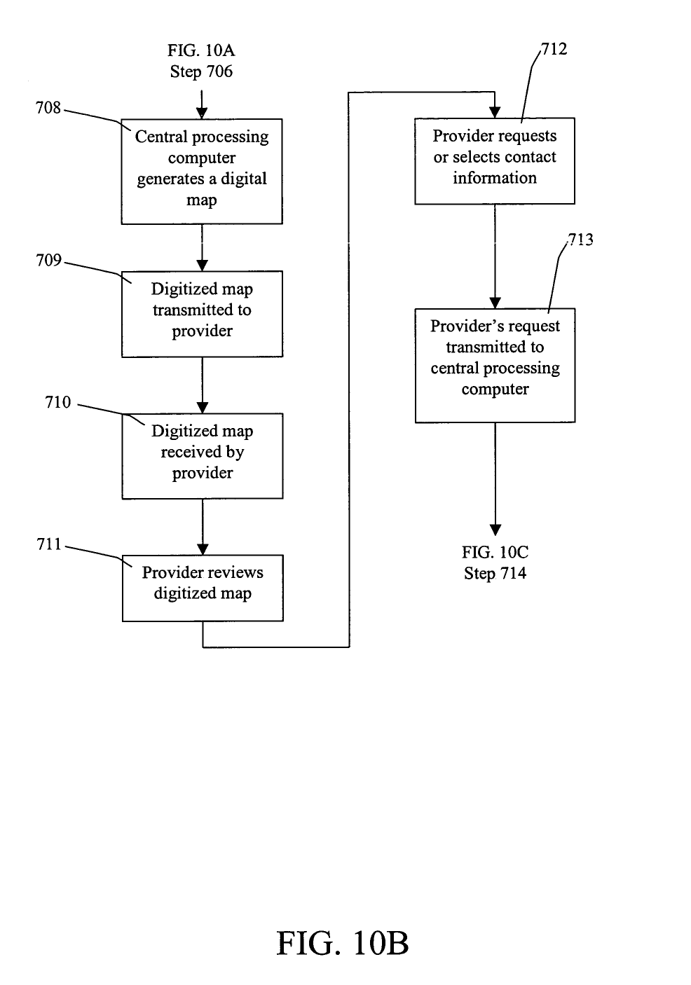

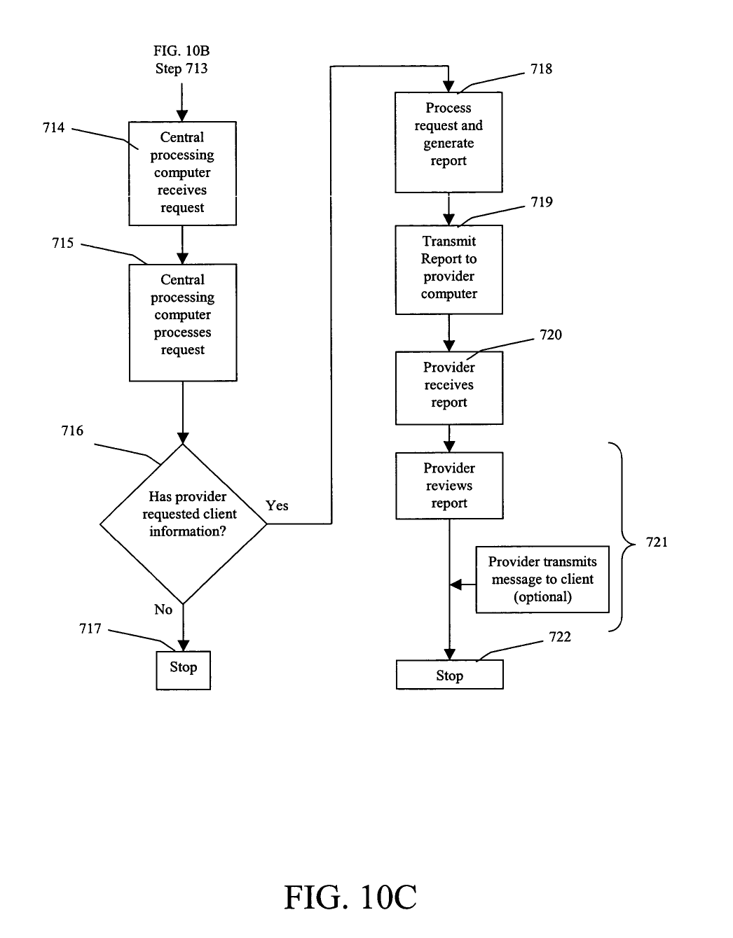

In another preferred embodiment, the apparatus and method of the present invention can be utilized in order to provide a provider with a digitized map displaying the location of any clients in the provider's geographic or physical proximity who or which have or may have shipment or delivery requirements which need to be fulfilled or which may need to be fulfilled. FIGS. 10A, 10B and 10C illustrate another preferred embodiment method for utilizing the present invention, in flow diagram form. In the embodiment of FIGS. 10A, 10B and 10C, the apparatus of the present invention can utilize vehicle position or location data in order to determine the vehicle's location on a digitized map of a region or locale. The vehicle's position or location can be placed on a digitized map.

The position or location of any clients or potential clients can also be placed on the same digitized map so that the relative positions or locations of the provider and the clients or potential clients can be ascertained by the provider who may access the digitized map, and the position or location data, at the vehicle and via the provider computer 30. The digitized map may also be accessed by any of the clients or potential clients who or which may then ascertain the availability of a provider or providers. The clients or potential clients can also obtain information regarding clients or potential clients who or which may be competing for the services of the same provider or providers. The digitized map can also be accessed by any employer, broker, agent, or any third parties, of or for any other providers described herein who may be servicing or providing supervisory services, support services, or management services, for or on behalf of any of the providers described herein.

Applicant hereby incorporates by reference herein the subject matter and teachings of U.S. Pat. No. 5,959,577 which teaches a Method and structure for distribution of travel information using network.

In the embodiment of FIGS. 10A, 10B, and 10C, the various providers can provide positioning and/or location information to the central processing computer 10 regarding their position or location. The position or location information can be obtained from the respective position and/or location device(s) 30J.

Any of the providers described herein can elect to have their position or location made available to the central processing computer 10 at any desired time and/or at all times. The position or location data for any of the providers can be transmitted from the providers' respective provider computers 30 and/or from the providers' respective position and/or location devices 30J to the central processing computer 10 so as to facilitate this mode of operation.

Clients or potential clients can provide their position or location information to the central processing computer 10 as well. In the case of fixed location clients, this position or location information may be provided to the central processing computer 10 and can be stored in the database 10H therein to be utilized over and over again. In the case of mobile clients, such as those operating from mobile facilities, or providers who may need to hire the services of other providers, such as in the case of providers who may experience vehicle breakdown prior to completing a shipment or delivery, the position or location information can be provided at any time, by either manual or automatic entry and transmission to the central processing computer 10 and/or by transmission from a position and/or location device 20J located at or associated with the client or clients and/or at or associated with a client computer 20.

With reference to FIGS. 10A, 10B and 10C, the operation of the apparatus 100 commences at step 700. At step 701, the provider accesses the central processing computer 10 via the provider computer 30. At step 702, the provider can either enter his of her position or location information or transmit the information obtained via the position and/or location device 30J.

At step 702, the provider can also enter information regarding the provider's availability, available cargo capacity, and/or the provider's desire to locate and/or secure an assignment(s), a job(s), and/or an engagement. The provider, at step 702, can also specify the size of the region from which he or she desires to obtain an assignment or job. At step 702, the provider can also enter information regarding the type of assignment or job he or she desires to secure as well as any conditions which may be attached thereto (i.e. size of shipment, nature of shipment, desired price for shipment or delivery, etc.).

At step 703, the information entered by the provider, and/or provided by the position and/or location device 30J, at step 702, is transmitted to the central processing computer 10. At step 704, the central processing computer 10 will receive the information. At step 705, the central processing computer 10 will process the information. At step 706, the central processing computer 10 will determine if any matchers exist in the provider's requested area of interest. If, at step 706, the central processing computer 10 determines that no matches exist in the provider's requested area of interest, the provider will be so notified and the operation of the apparatus 100 will cease at step 707.

If, at step 706, the central processing computer 10 determines that matches exist or have been identified, the central processing computer 10 will, at step 708, generate a digitized map of the desired area or region which can include the provider's position or location thereon, as well as the position or location of each client(s) matching the provider's criteria.

The digitized map can also provide position or location information of other providers who or which may be in the area or region. This information, if requested and/or if available, can be utilized to apprise a provider of the potential competition in the area, which information can be utilized by the provider in any appropriate manner. For example, the provider can lower its price, decide to travel out of a provider congested area or region and/or can, in any other manner, utilize this information for his or her benefit.

The central processing computer 10 can also, at step 708, generate and/or process information which can identify each client on the digitized map as well as provide contact information for each respective client. For example, each client who or which is identified on the digitized map can have a number, letter, or other symbol associated therewith. The provider can request contact information for the client by referencing the respective number, letter, or symbol.

At step 709, the digitized map is transmitted to the provider computer 30. At step 710, the digitized map is received at the provider computer and displayed to the provider on the display device 30E. At step 711, the provider can review the digitized map showing his or her relative position or location with respect to the location of clients or potential clients. At step 712, the provider can request or select contact information, and/or any other information, regarding the clients or potential clients identified on the digitized map, and/or any other information regarding the clients' requirements or needs.

At step 713, the provider's request is transmitted to the central processing computer 10. At step 714, the central processing computer 10 will receive the provider's request. At step 715, the central processing computer 10 will process the request. At step 716, the central processing computer 10 will determine whether the provider has requested contact information or any other information regarding any of the clients or potential clients. If, at step 716, the central processing computer 10 determines that the provider has not requested information regarding any of the clients or potential clients, the operation of the apparatus 100 will cease at step 717.

If, at step 716, it is determined that the provider has requested contact information and/or any other information regarding any of the clients or potential clients, the central processing computer 10 will process the request at step 718 and generate an appropriate informational report. At step 719, the central processing computer 10 will transmit the informational report to the provider computer 30. At step 720, the provider computer 30 will receive the informational report.

At step 721, the provider can view or print the report and utilize the information provided therein in order to contact and negotiate with any of the clients or potential clients identified therein. At step 721, the provider can also transmit a message, such as an e-mail message, a telephone message, a facsimile message, a beeper or pager message, and/or any other electronic transmission, directly to the client computer 20 and/or any other communication device associated with the client or clients, in order to make contact and/or negotiate an agreement to provide shipment and/or delivery services for the client or clients. Thereafter, the operation of the apparatus 100 will cease at step 722.

In the embodiment of FIGS. 10A, 10B and 10C, the apparatus and method of the present invention provides a system for enabling a provider to identify assignment and/or job opportunities and enter into agreements for same from a mobile platform and from his or her present location.

In another preferred embodiment, the digitized map or maps can be updated as the provider enters a new or different area or region of interest which may have new client postings, thereby providing updated client identification and location information. Digitized map or maps can also be updated as new clients become available in a given area or region.

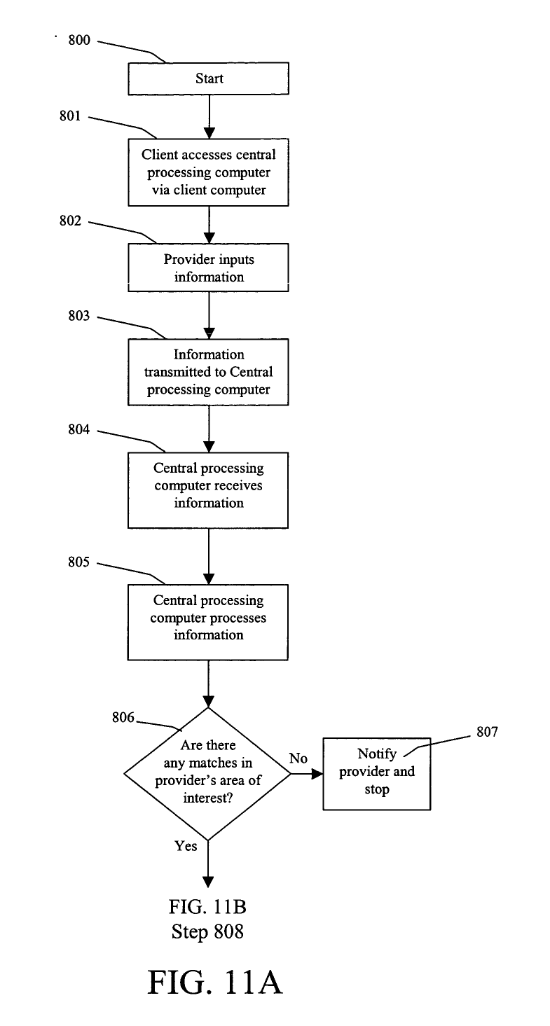

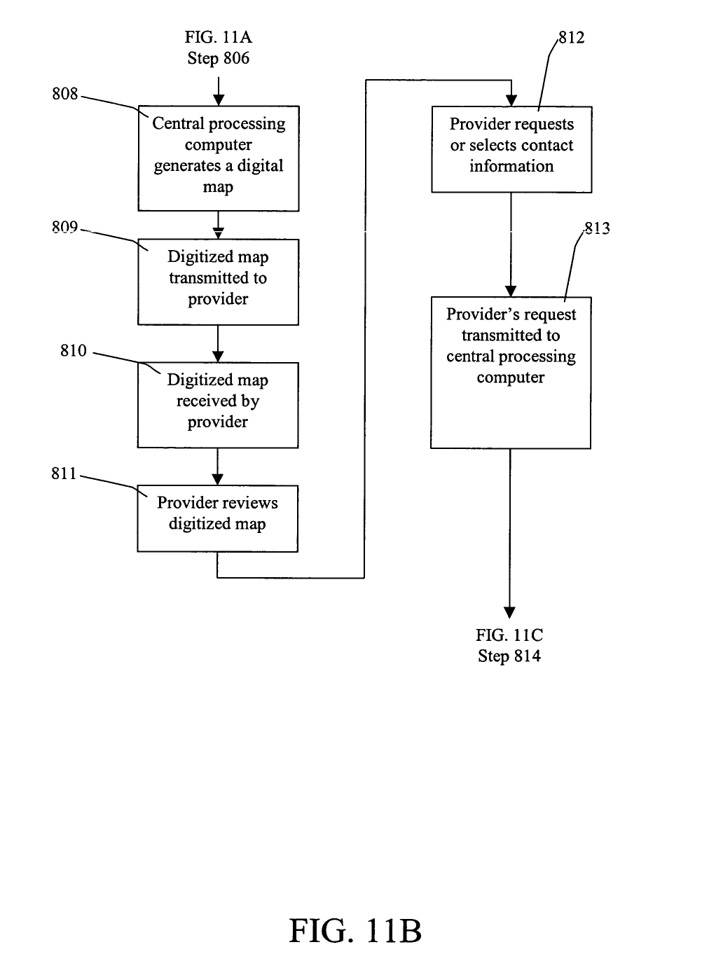

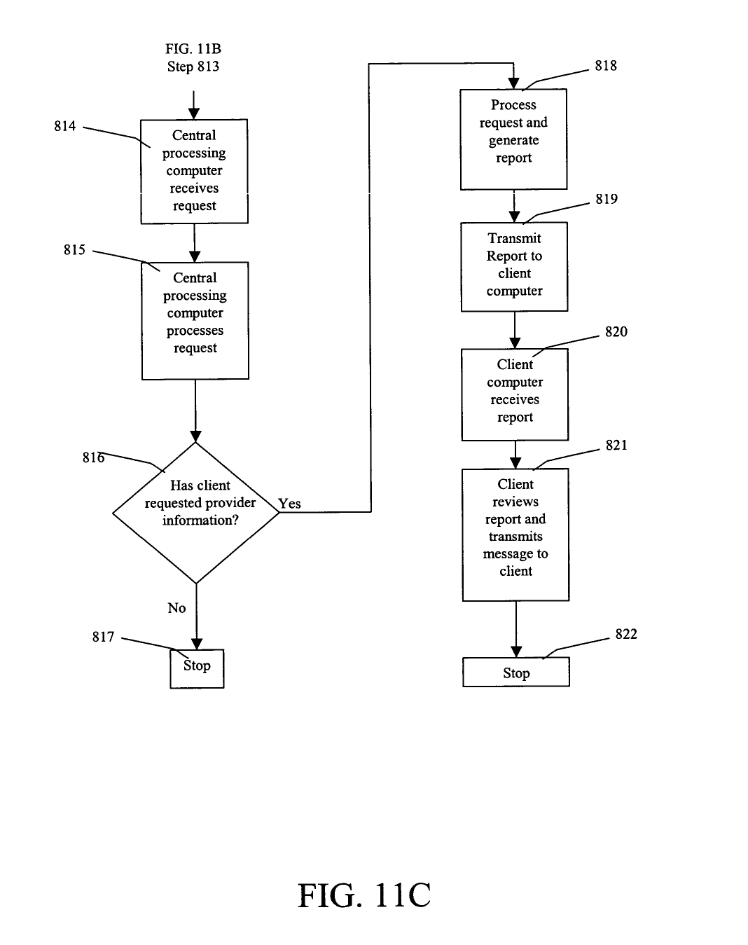

In another preferred embodiment, the preferred embodiment of FIGS. 10A, 10B and 10C can be utilized by a broker, an agent, and/or a representative, of a provider or group of providers, and/or by any other third party, in order to utilize the above-described embodiment on behalf of any of the respective parties. in another preferred embodiment, the apparatus and method of the present invention can be utilized in order to provide a client with a digitized map displaying the location of any providers in the client's geographic region or area who are or who may be available to handle any shipment or delivery needs of the client(s). FIGS. 11A, 11B and 11C illustrate another preferred embodiment method for utilizing the present invention, in flow diagram form.

In the embodiment of FIGS. 11A, 11B and 11C, the apparatus of the present invention can utilize the client's position or location data in order to determine the client's position or location on a digitized map of the area or region in which the client is located. The apparatus 100 can also utilize the vehicle position or location data of a provider(s) in the area or region in order to determine the location of the provider(s) on a digitized map of the area, region, or locale. The position or location of any provider(s) can also be placed on the same digitized map so that the relative positions or locations of the client and the provider(s) can be ascertained by the client.

The digitized map may also be accessed by any provider or providers who or which may then ascertain the availability of an assignment(s) or job(s) as well as information regarding other providers who or which may be competing, or who or which can compete, to obtain the same assignment(s) or job(s) from the same client(s).

The digitized map can also be accessed by any employer, broker, agent, or any third parties, of or for any other clients described herein who may be servicing or providing supervisory services, support services, or management services, for or on behalf of any of the clients described herein.

In the embodiment of FIGS. 11A, 11B and 11C, the various clients can provide positioning information to the central processing computer 10 regarding their position or location from their respective client computers 20. This position or location information may be provided to the central processing computer 10 and stored in the database 10H therein so as to be utilized over and over again.

In the case of mobile clients, such as those operating from mobile facilities, or providers who may need to hire the services of other providers, such as in the case of provider vehicle breakdown prior to completing a shipment or delivery, the position or location information can be provided at any time, by either manual or automatic entry and transmission to the central processing computer 10 and/or by transmission from a position and/or location device located at or associated with the client or clients. In turn, providers can provide their position or location information to the central processing computer 10 via their respective position and/or location devices 30J and/or their respective provider computers 30. Any of the providers described herein can elect to have their position or location made available to the central processing computer 10 at any desired time and/or at all times and can transmit position or location data from the provider computer 30 and/or from the position and/or location device 30J to the central processing computer 10 so as to facilitate this mode of operation.

With reference to FIGS. 11A, 11B and 11C, the operation of the apparatus 100 commences at step 800. At step 801, the client accesses the central processing computer 10 via the client computer 20. At step 802, the client can either enter its position or location information and/or enter its identification information. At step 802, the client can also enter information regarding its shipment or delivery needs or requirements along with any conditions associated with same. At step 802, the client can also specify the size of the region from which he or she desires to obtain information about available providers. At step 802, the client can also enter information regarding the type of provider it desires to secure as well as any conditions which may be attached to the client's requirements (i.e. size of shipment, nature of shipment, desired price the client is willing to pay for the shipment or delivery, etc.).

At step 803, the information entered by the client, at step 802, is transmitted to the central processing computer 10.

At step 804, the central processing computer 10 will receive the information. At step 805, the central processing computer 10 will process the information in conjunction with the stored provider information in order to determine if any matches exist in the client's requested area of interest. At step 806, the central processing computer 10 will determine if any matches exist and/or have been identified. If, at step 806, the central processing computer 10 determines that no matches exist for the client's requirements, the operation of the apparatus 100 will cease at step 807.

If, at step 806, the central processing computer 10 determines that matches exist and/or have been identified, then the central processing computer 10 will, at step 808, generate a digitized map of the desired area or region which can include the client's position or location thereon, as well as the position or location of providers matching the client's criteria.

The digitized map can also provide the position or location information of other clients who or which may be in the area or region. This information, if requested and/or if available, can be utilized to apprise a client of the potential competition in the area, which information can be utilized by the client in any suitable or appropriate manner. For example, the client can raise the price it is willing to pay, decide to make other shipment or delivery arrangements, and/or in any other way utilize this information for its benefit. The central processing computer 10 can also, at step 808, generate and/or process information which can identify each provider on the digitized map as well as provide contact information for each respective provider. For example, each provider identified on the digitized map can have a number, letter, or other symbol associated therewith. The client can request contact information for the provider by referencing the respective number, letter, or symbol.

At step 809, the digitized map is transmitted to the client computer 20. At step 810, the digitized map is received at the client computer 20 and displayed to the client on the display device 20E. At step 811, the client can review the digitized map showing his or her relative position or location with respect to providers. At step 812, the client can request or select contact information, and/or any other information, regarding any of the providers identified on the digitized map, and/or any other information regarding the providers' requirements or conditions. At step 813, the client's request or selection is transmitted to the central processing computer 10. At step 814, the central processing computer 10 will receive client's request or selection. At step 815, the central processing computer 10 will process the request or selection and determine whether the client has requested contact information or any other information regarding any of the providers.

At step 816, the central processing computer 10 will determine if the client has requested provider contact information. If, at step 816, the central processing computer 10 determines that the client has not requested information regarding any of the providers, the operation of the apparatus 100 will cease at step 817.

If, at step 816, it is determined that the client has requested contact information and/or any other information regarding any of the providers, the central processing computer 10 will process the request or selection at step 818 and generate the appropriate informational report. At step 819, the central processing computer 10 will transmit the informational report to the client computer 20. At step 820, the client computer 20 will receive the informational report.

At step 821, the client can view or print the report and utilize the information to contact and negotiate with any of the providers identified therein. At step 821, the client can also transmit a message, such as an e-mail message, a telephone message, a facsimile message, a beeper or pager message, and/or any other electronic transmission, directly to the provider(s) computer 30 and/or any other communication device associated with the provider(s), in order to make contact and/or negotiate an agreement to obtain shipment and/or delivery services from the provider(s). Thereafter, the operation of the apparatus 100 will cease at step 822.

In the embodiment of FIGS. 11A, 11B and 11C, the apparatus and method of the present invention provides a system for enabling a client to identify providers who may fulfill its shipment or delivery requirements or needs and enter into agreements for obtaining these respective services.

In another preferred embodiment, the preferred embodiment of FIGS. 11A, 11B and 11C can be utilized by a broker, an agent, and/or a representative, of a client or group of clients, and/or by any other third party, in order to utilize the above-described embodiment on behalf of any of the respective parties.

In another preferred embodiment, the digitized map or maps can be updated as new or different providers enter an area or region of interest, thereby providing updated provider identification and location information. The digitized map or maps can also be updated as new providers become available in a given area or region.

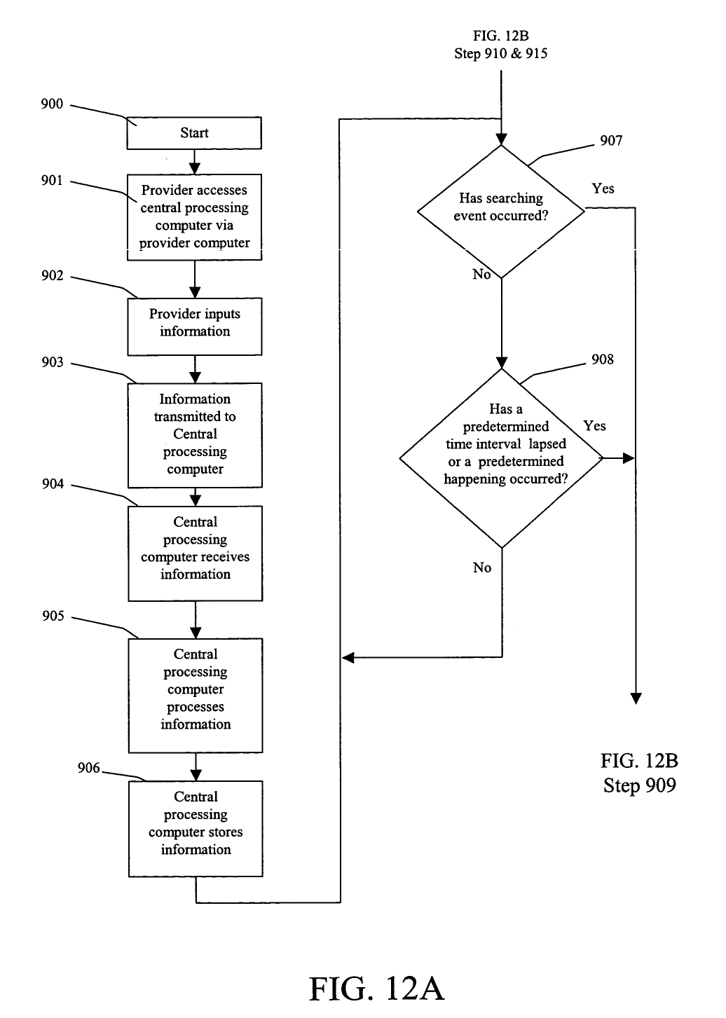

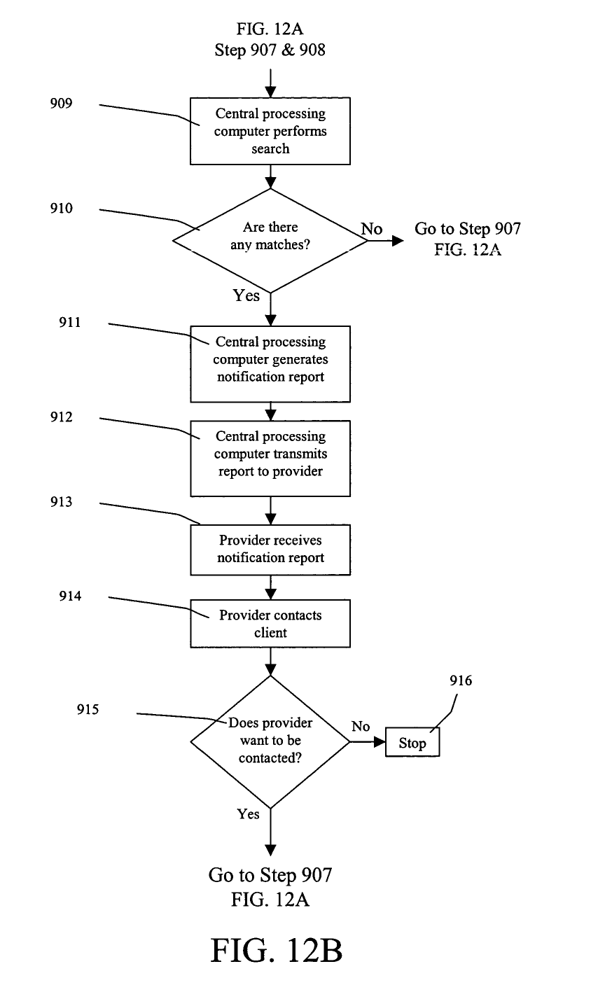

In another preferred embodiment, the apparatus and method of the present invention can be utilized to provide a provider with notification upon the posting of shipment and/or delivery assignments by any of the clients described herein. FIGS. 12A and 12B illustrate another preferred embodiment for utilizing the apparatus of the present invention, in flow diagram form.

With reference to FIGS. 12A and 12B, the operation of the apparatus 100 commences at step 900. At step 901, the provider accesses the central processing computer 10 via the provider computer 20. At step 902, the provider will enter parameters, characteristics, and/or conditions, associated with and/or regarding, any shipment or delivery assignments or jobs the availability of which the provider would like to receive notification.

For example, the provider may want to be notified upon the posting of certain shipment or delivery assignments or jobs, the posting of certain shipment or delivery assignments or jobs for certain goods or products, the posting of certain shipment or delivery assignments or jobs for certain times, the posting of shipment or delivery assignments or jobs for a certain client(s), the posting of shipment or delivery assignments or jobs for certain geographical areas, the posting of shipment or delivery assignments or jobs having certain shipment or delivery fees associated therewith, origin(s) of shipment(s), destination(s) of shipment(s), and/or date(s) of shipment(s), and/or the posting of any shipment or delivery assignments or jobs which may be of any interest to a provider, and/or any other information which may be of interest to the provider.

At step 902, the provider can also enter his or her contact information as well at the mode and manner of communication and/or notification (i.e. e-mail message, telephone call/message, facsimile transmission, beeper or pager message, mail message, etc.).

At step 902, the provider can also provide searching instructions and/or criteria for instructing or requesting searches by the central processing computer 10. For example, the provider can request that searches be performed for assignments or jobs at various time intervals, at fixed time intervals, upon the posting of certain assignments or jobs, upon the posting of assignments or jobs by certain clients, upon the posting of assignments or jobs having certain compensation levels associated therewith, and/or upon the posting of any other information of interest to the provider and/or the occurrence of any pre-specified event which may be of interest to the provider.

At step 903, the information, parameters, characteristics, and/or conditions, and any other information entered by the provider at step 902 is transmitted to the central processing computer 10. At step 904, the information, parameters, characteristics, and/or any conditions, and other information entered by the provider at step 902, are received at the central processing computer 10. At step 905, the central processing computer 10 will process the received information, parameters, characteristics, and/or conditions, and other information. At step 906, the central processing computer 10 will store the received information, parameters, characteristics, and/or conditions, and other information, in the database 10H. Thereafter, the central processing computer 10 will, at step 907, await the occurrence of a searching event.

At any time, any client can access the central processing computer 10 via the client computer 20 and post information regarding a shipment or delivery requirement, need, assignment or job. The information entered by the client can include the client's location(s), the nature of the shipment(s), the destination(s) of the shipment(s), date(s) of shipment(s), offering price(s) for the shipment(s), and/or any other information and/or conditions regarding and/or related to the shipment or delivery assignment or job. The information entered by the client can then be transmitted to the central processing computer 10 wherein it will be received, processed and stored in the database 10H.

At step 908, an elapsing of a pre-specified time interval, the occurrence of any event, occurrence, posting, and/or any other happening, defined by the provider as being a searching event, can occur thereby activating the central processing computer 10 to perform a search. At step 909, the central processing computer 10 will perform a search of all assignments or jobs posted therewith in order to determine if any of these assignments or jobs match the criteria provided by the provider and for which the provider desires to be notified.

At step 910, the central processing computer 10 will determine if any matches have been found. If at step 910, it is determined that matches have been found, the operation will proceed to step 911 and the central processing computer 10 will generate a notification report containing those assignments or jobs for which the provider is to, or wants to, be notified. The notification report will also contain information regarding the assignments or jobs, the client(s) posting same and any contact information for enabling the provider to make contact with the client or clients. If, at step 910, it is determined that no matches were found, the operation of the apparatus 100 will proceed to step 907 and await a next searching event.

At step 912, the notification report will be transmitted to the provider's provider computer 30. At step 913, the provider can receive the notification report on the provider computer 30 and can view the notification report on the display device 30E.

At step 913, the provider can also obtain any contact information regarding any of the clients posting assignments or jobs. Thereafter, the provider can, at step 914, contact each client(s) and pursue discussions and/or an agreement with the client(s). At step 915, the central processing computer 10 will ascertain whether the provider has instructed the central processing computer 10 to continue to notify the provider of future opportunities. If, at step 915, the central processing computer 10 determines that that provider desires to be notified of future opportunities, then the processing will proceed to step 907 and the central processing computer 10 will await the next searching event. If, however, it is determined, at step 915, that the provider does not desire to be notified of future opportunities, then the operation of the apparatus 100 will cease at step 916.

In another preferred embodiment, a broker, agent, and/or other third party representative, can enter any of the information described herein, in the embodiment of FIGS. 12A and 12B, for or on behalf of any of the respective providers and/or clients.

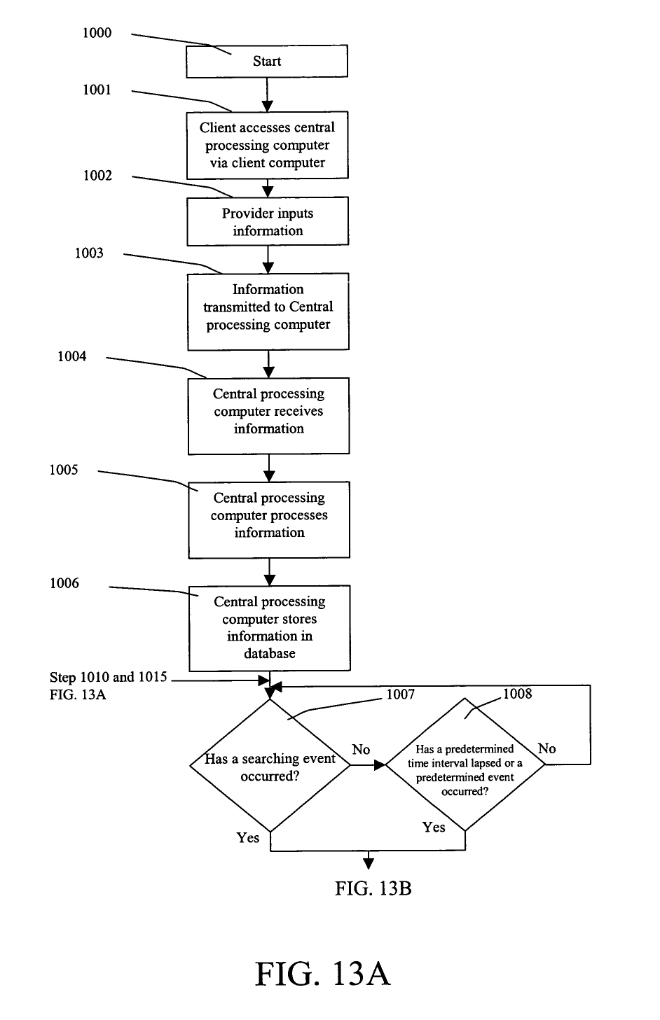

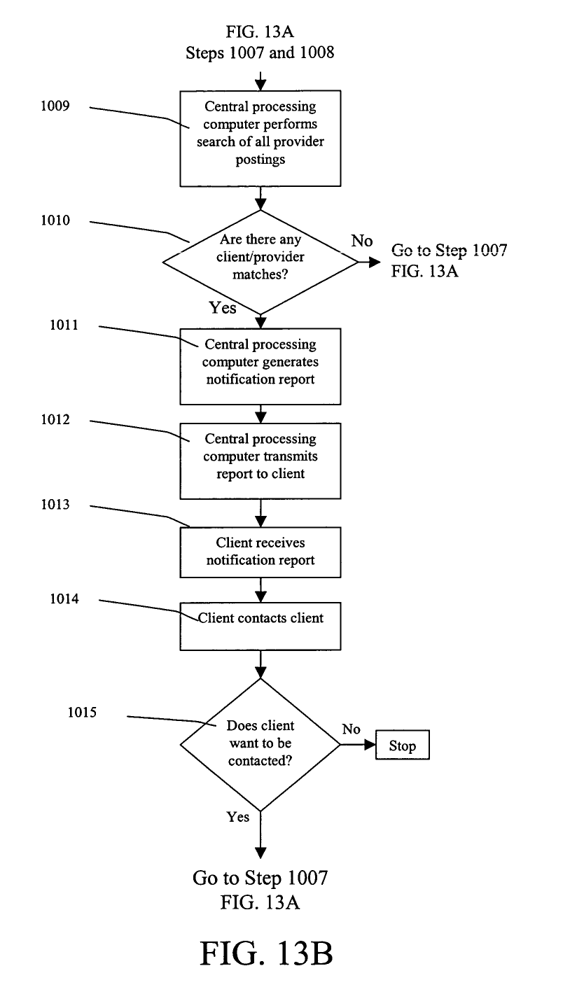

In another preferred embodiment, the apparatus and method of the present invention can be utilized to provide a client with notification upon the posting by any provider(s) of their availability to perform shipment or delivery services. FIGS. 13A and 13B illustrate another preferred embodiment for utilizing the apparatus of the present invention, in flow diagram form. With reference to FIGS. 13A and 13B, the operation of the apparatus 100 commences at step 1000.

At step 1001, the client accesses the central processing computer 10 via the client computer 20. At step 1002, the client will enter parameters, characteristics, and/or conditions, associated with and/or regarding, any shipment or delivery services and/or providers, the existence or availability of which the client would like to receive notification. For example, the client may want to be notified upon the posting of the availability of a certain provider or type of provider, the posting of a certain provider's schedule, the posting of a provider(s) for shipping or delivering certain goods of products, the posting of a provider(s) having a certain location, work area, and/or pick-up or delivery times and/or schedules, the posting of providers having certain rate or fee schedules, the posting of providers having a certain service area(s), the posting of providers having special skills in the shipment or delivery of certain goods or products, the posting of providers having a certain origin(s) of shipment(s) and/or destination(s) of shipment(s), the posting of providers having a certain date(s) of shipment(s), and/or the posting of any providers having any characteristics which may be of any interest to a client, and/or any other information which may be of interest to the client.

At step 1002, the client can also enter its contact information as well as the mode and manner of communication and/or notification (i.e. e-mail message, telephone call/message, facsimile transmission, beeper or pager message, mail message, etc.). At step 1002, the client can also provide searching instructions and/or criteria for instructing or requesting searches by the central processing computer 10. For example, the client can request that searches be performed for providers at various time intervals, at fixed time intervals, upon the posting of the availability of certain providers, upon the posting of the providers having specialized skills regarding certain goods or products, upon the posting of providers having a certain rate or fee structure, and/or upon the posting of any other information of interest to the client and/or the occurrence of any pre-specified event which may be of interest to the client.

At step 1003, the information, parameters, characteristics, and/or conditions, and any other information entered by the client at step 1002 are transmitted to the central processing computer 10. At step 1004, the information, parameters, characteristics, and/or conditions, and any other information entered by the client at step 1002 are received at the central processing computer 10. At step 1005, the central processing computer 10 will process the received information, parameters, characteristics, and/or conditions, and any other information.

At step 1006, the central processing computer 10 will store the received information, parameters, characteristics, and/or conditions, and other information, in the database 10H. Thereafter, the central processing computer 10 will, at step 1007, await the occurrence of a searching event.

At any time, any provider can access the central processing computer 10 via the provider computer 30 and post information regarding the provider's availability to perform services, the types of services, shipments, or deliveries, the provider(s) can perform, the provider's shipment, delivery, or cargo, requirements, the provider's conditions of engagement, and/or any other information which may be provided by the provider and/or which may be of interest to the provider and/or to the client. The information entered by the provider can include the provider's location, the nature of the provider's services, the provider's typical destinations, the provider's typical dates of shipments, work schedules, fees or charges for shipments or deliveries, and/or any other information and/or conditions regarding and/or related to the provider's services. The information entered by the provider can then be transmitted to the central processing computer 10 wherein it will be received, processed and stored in the database 10H.

At step 1008, an elapsing of a pre-specified time interval, the occurrence of any event, occurrence, posting, and/or any other happening, defined by the client as being a searching event, can occur thereby activating the central processing computer 10 to perform a search. At step 1009, the central processing computer 10 will perform a search of all provider postings which are posted therewith in order to determine if any of these provider postings match the criteria provided by the client and for which the client is to, or desires to, be notified.

At step 1010, the central processing computer 10 will determine if any matches have been found. If at step 1010, it is determined that matches have been found, the operation will proceed to step 1011 and the central processing computer 10 will generate a notification report containing those provider(s) or provider postings for which the client wants to be notified. The notification report will also contain information regarding the providers, the provider posting, and any contact information for enabling the client to make contact with the provider or providers. If, at step 1010, it is determined that no matches were found, the operation of the apparatus 100 will proceed to step 1007 and await a next searching event.

At step 1012, the notification report will be transmitted to the client's client computer 20. At step 1013, the client can receive the notification report on the client computer 20 and can view the notification report on the display device 20E. At step 1013, the client can also obtain any contact information regarding any of the providers who provided provider postings. Thereafter, the client can, at step 1014, contact each provider and pursue discussions and/or an agreement(s) with the provider(s).

At step 1015, the central processing computer 10 will ascertain whether the client has instructed the central processing computer 10 to continue to notify the client of future opportunities. If, at step 1015, the central processing computer 10 determines that the client desires to be notified of future opportunities, then the processing will proceed to step 1007 and the central processing computer 10 will await the next searching event. If, however, it is determined, at step 1015, that the client does not desire to be notified of future opportunities, then the operation of the apparatus 100 will cease at step 1016.

In another preferred embodiment, a broker, agent, and/or other third party representative, can enter any of the information described herein, in the embodiment of FIGS. 13A and 13B, for or on behalf of any of the respective clients and/or providers.

In another preferred embodiment, the apparatus and method of the present invention can be utilized to provide various services for and/or on behalf of any of the respective providers and/or clients who or which utilize the present invention. For example, the present invention can be utilized to provide contract formation services, provide contracts, provide shipping invoices, provide bills of lading, provide packing slips, provide and/or perform billing services, provide and/or perform fee collection services, and/or provide or perform any other services which may be related to and/or which may be incidental to any of the relationships which are described herein and/or which are established via the present invention.

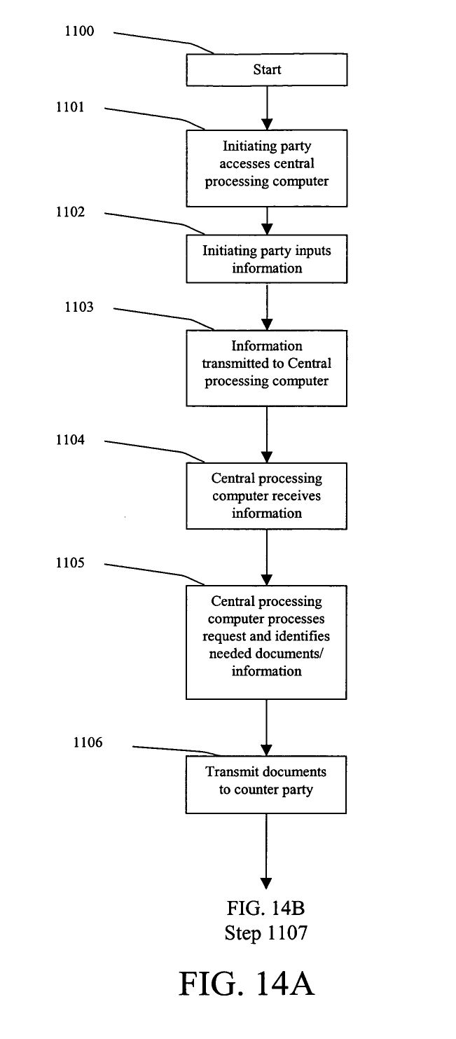

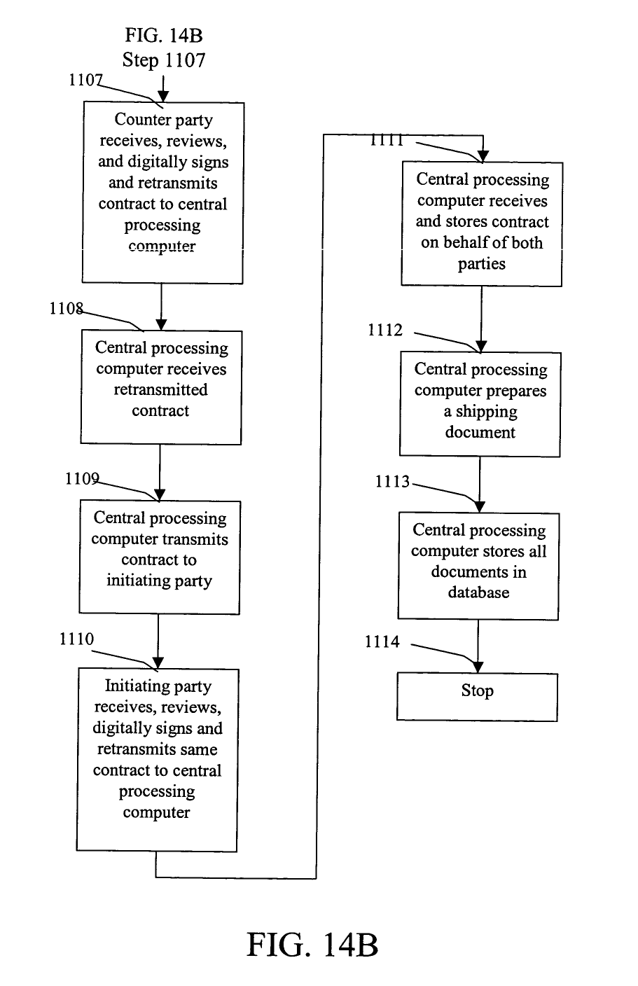

FIGS. 14A and 14B illustrate another preferred embodiment method for utilizing the present invention, in flow diagram form. In the embodiment of FIGS. 14A and 14B, the database 10H of the central processing computer 10 can contain any and/or all of the documents, forms, files, and/or other information for facilitating the generation of and/or the preparation of contracts and/or any other legal instruments, shipping invoices and/or documents, bills of lading and/or related documents, packing slips and/or related documents, transfer documents and/or related documents, customs documents and/or related documents, billing documents, and/or fee collection documents.

With reference to FIGS. 14A and 14B, the operation of the apparatus 100 commences at step 1100. At step 1101, the party initiating a transaction can access the central processing computer 10. For the sake of simplicity, the preferred embodiment will be described by using a provider as the initiating party. However, it is to be understood that a client can just as easily and readily utilize the present invention as an initiating party.

Returning once again to step 1101, the provider can access the central processing computer 10 via the provider computer 30. At step 1102, the provider can enter information regarding the counterparty client he or she is dealing with and/or the nature of the services to be performed for the client.

At step 1102, the provider can also enter information regarding the service(s) or function(s) which he or she requires assistance with. While any function appurtenant to the shipment or delivery relationship can be provided by the apparatus 100 for any of the parties, the present embodiment will describe providing contracting services for or between the parties. This may also entail providing documents such as shipping invoices, insurance, insurance documents, billing invoices, and fee collection documents, as appropriate.

At step 1103, the provider can transmit the entered information to the central processing computer 10. At step 1104, the information is received by the central processing computer 10. At step 1105, the central processing computer 10 will process the request and identify the documents and/or information needed to service the request. If the request was for providing a contract for services, the contract will be generated. Further any other needed documents can also be generated.

At step 1106, the contract will be transmitted to the client computer 20 of the counterparty client. At step 1107, the client can receive, review, and attach a digital signature to, the contract, and re-transmit same to the central processing computer 10. At step 1108, the central processing computer 10 can receive the client “signed” contract. At step 1109, the central processing computer 10 can transmit the client “signed” contract to the provider computer 30. The provider, at step 1110, can receive, review, and attach a digital signature to, the contract, and re-transmit same to the central processing computer 10. At step 1111, the central processing computer 10 can receive and store the contract on behalf of both parties who may access and download a copy of same at any time. In another preferred embodiment, the central processing computer 10 can notify a respective party when a counterparty has “signed” and returned a contract.

At step 1112, the central processing computer 10 can prepare a shipping invoice(s), an insurance policy or form, and/or a billing document or form, and/or any other ancillary, related, and/or referenced, documents and/or forms, which may be called for and/or which may be referenced in the contract. At step 1113, all of the herein-described contracts and/or documents or forms can be stored in the database 10H. The parties can also download any of these shipping, insurance, and/or billing, documents or forms from the central processing computer 10 at any time. Thereafter, the operation of the apparatus 100 will cease at step 1114.

In another preferred embodiment, the apparatus 100 and/or the central processing computer 10 can administer and/or manage financial accounts for any of the providers and/or clients described herein. In this manner, the apparatus 100 and/or the central processing computer 10 can effect financial and/or monetary transfers to, from, and/or between, any of the financial accounts for any of the parties described herein, thereby providing a billing and payment clearing platform for any of the financial transactions which can be facilitated by the apparatus and method of the present invention.

In another preferred embodiment, any of the herein-described parties, clients, providers, and/or operators or administrators who or which utilize the present invention can monitor and/or track a shipment or delivery by accessing the central processing computer 10 and ascertaining provider position or location by obtaining same from the position and/or location device 30J and/or the provider computer 30 associated with the provider handling the shipment or delivery. In this manner, any user of the present invention can monitor and/or track the position, location, and/or route taken by any provider in providing shipment, transport, cargo transport, and/or delivery services.

The apparatus 100 of the present invention, in any and/or all of the embodiments described herein, can also be programmed to be self-activating and/or activated automatically.

In any and/or all of the embodiments described herein, any interactions, negotiations, and/or deals reached, between any of the parties, can be monitored and/or can be recorded by the central processing computer 10 and be stored in the database 10H.

In any and/or all of the embodiments described herein, the present invention can be utilized in conjunction with dispatch algorithms, dispatching algorithms, and/or software programs and/or routines for processing dispatching information. The dispatch information or dispatching information can be processed as a function of provider position, provider available cargo capacity, priority of load, cargo type, provider past performance rating and/or information, and/or any other information and/or factors which can or should be considered in processing dispatch or dispatching information. The dispatch algorithm and/or dispatching algorithms can also utilize any other data and/or information which can or which may be related to and/or relevant to shipping, transport, and/or delivery commerce.

The apparatus and method of the present invention can also be utilized in transactions involving commerce of any kind, electronic commerce (e-commerce), and/or mobile commerce (m-commerce).

The present invention, in any and/or all of the herein-described embodiments, can utilize electronic commerce technologies and security methods, techniques and technologies, as described and as set forth in Electronic Commerce Technical, Business, and Legal Issues, Nabil R, Adam, et al. Prentice Hall, 1999 and Web Security & Commerce, Simson Garfinkel with Gene Spafford, O'Reilly 1997, the subject matter of which are hereby incorporated by reference herein.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, third generation (3G) communication networks or systems, broadband communication networks or systems, low earth orbiting satellite (LEOs) networks or systems, as well as in, or on, any internets and/or intranets, the Internet, the World Wide Web, and any other suitable communication network or system.

Any and/or all of the data and/or information described herein, which is stored in the database 1 OH, or in the collection of databases, can be linked via relational database techniques and/or via any appropriate database management techniques. The data and/or information, in the preferred embodiments, can be updated via inputs from the respective clients, providers, and/or entities, and/or an administrator or operator of the apparatus 100 and/or the central processing computer 10. The above-described updates can also be provided from other information sources via the communication network.

The data and/or information stored in the database 10H, or in the collection of databases, and/or any other databases utilized in conjunction with the present invention, can be updated by each of the respective individuals and/or entities described herein, and/or an administrator or operator of the apparatus 100 or the central processing computer 10, in real-time or otherwise, and/or via dynamically linked database management techniques.

In view of the foregoing, the apparatus and method of the present invention can be utilized to facilitate various electronic commerce activities and/or related activities in the shipping, transporting, cargo transporting, and/or delivery fields and/or industries. The apparatus and method of the present invention can be utilized by any of the herein-described providers and clients so as to provide improved services and efficiencies in the shipment, transportation, and delivery services fields and industries.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments with the scope of the present invention being limited only by the claims which follow.

What is claimed is:

1. An apparatus for providing shipment information, comprising:
a receiver for receiving a request to obtain information regarding at least one of a shipment and a delivery, wherein said request is received from a requesting individual;
a processor for processing said request to obtain information in conjunction with information regarding at least one of a shipment assignment, a shipment job, a delivery assignment, and a delivery job, and further wherein said processor generates a report in response to said request for information; and
a transmitter for transmitting said report to a communication device associated with the requesting individual.

2. The apparatus of claim 1, wherein said receiver receives a second request for at least one of additional information and contact information concerning said at least one of a shipment assignment, a shipment job, a delivery assignment, and a delivery job, wherein said processor processes said second request, and further wherein said transmitter transmits said at least one of additional information and contact information to the communication device associated with the requesting individual.

3. The apparatus of claim 1, further comprising:
means for monitoring at least one of negotiations between parties and agreements entered into between parties.

4. The apparatus of claim 1, wherein said apparatus is at least one of a central processing computer, a network computer, and a server computer.

5. The apparatus of claim 1, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

6. The apparatus of claim 1, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

7. An apparatus for providing shipment information, comprising:
a transmitter for transmitting a request to obtain information regarding at least one of a shipment and a delivery from a requesting individual to a central processing computer;
a receiver for receiving a report from the central processing computer in response to said request for information;
a processor for processing said report; and
a display device for displaying information contained in said report.

8. The apparatus of claim 7, wherein said transmitter transmits a second request for at least one of additional information and contact information, and further wherein said receiver receives said at least one of additional information and contact information.

9. The apparatus of claim 7, wherein the central processing computer is at least one of a central processing computer, a network computer, and a server computer.

10. The apparatus of claim 7, wherein said apparatus is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

11. The apparatus of claim 7, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

12. An apparatus for providing shipment information, comprising:
a receiver for receiving a request to obtain information regarding at least one of a provider of at least one of shipment and delivery services and an availability of a provider of at least one of shipment and delivery services, wherein said request is received from a requesting individual;
a processor for processing said request to obtain information in conjunction with information regarding at least one of a provider, providers, an available provider, and available providers, and further wherein said processor generates a report in response to said request for information; and
a transmitter for transmitting said report to a communication device associated with the requesting individual.

13. The apparatus of claim 12, wherein said receiver receives a second request for at least one of additional information and contact information concerning said at least one of a provider, providers, an available provider, and available providers, wherein said processor processes said second request, and further wherein said transmitter transmits said at least one of additional information and contact information to the communication device associated with the requesting individual.

14. The apparatus of claim 12, further comprising:
means for monitoring at least one of negotiations between parties agreements entered into between parties.

15. The apparatus of claim 12, wherein said apparatus is at least one of a central processing computer, a network computer, and a server computer.

16. The apparatus of claim 12, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

17. The apparatus of claim 12, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

18. An apparatus for providing shipment information, comprising:
a transmitter for transmitting a request to obtain information regarding at least one a provider, providers, an available provider, and available providers, to a central processing computer;
a receiver for receiving a report from the central processing computer in response to said request for information;
a processor for processing said report; and
a display device for displaying information contained in said report.

19. The apparatus of claim 18, wherein said transmitter transmits a second request for at least one of additional information and contact information, and further wherein said receiver receives said at least one of additional information and contact information.

20. The apparatus of claim 18, wherein the central processing computer is at least one of a central processing computer, a network computer, and a server computer.

21. The apparatus of claim 18, wherein said apparatus is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

22. The apparatus of claim 18, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

23. An apparatus for providing shipment information, comprising:
a receiver for receiving a request to obtain information regarding at least one of an auction and a bidding process, wherein said request is received from a requesting individual;
a processor for processing said request in conjunction with information regarding at least one of an auction, auctions, a bidding process, and bidding processes, wherein said processor generates a report regarding said at least one of an auction, auctions, a bidding process, and bidding processes, wherein said report contains at least one of time, place, site, and subject matter, of at least one of said at least one of an auction, auctions, a bidding process, and bidding processes; and
a transmitter for transmitting said report to a communication device associated with the requesting individual.

24. The apparatus of claim 23, wherein said receiver receives at least one of a bid and an offer in at least one of an auction and a bidding process, wherein said processor determines whether said at least one of a bid and an offer is successful, and further wherein said processor generates a notification report in response to said at least one of a bid and an offer being successful.

25. The apparatus of claim 23, wherein said apparatus is at least one of a central processing computer, a network computer, and a server computer.

26. The apparatus of claim 23, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

27. An apparatus for providing shipment information, comprising:
a transmitter for transmitting a request to obtain information regarding at least one of an auction and a bidding process to a central processing computer;
a receiver for receiving a report, wherein said report contains at least one of time, place, site, and subject matter, of at least one of said at least one of an auction, auctions, a bidding process, and bidding processes;
a processor for processing said information contained in said report; and
a display device for displaying at least a portion of said information contained in said report.

28. The apparatus of claim 27, wherein said transmitter transmits at least one of a bid and an offer in at least one of an auction and a bidding process to the central processing computer, and further wherein said receiver receives a notification report regarding whether the at least one of a bid and an offer is one of successful and unsuccessful.

29. The apparatus of claim 27, wherein the central processing computer is at least one of a central processing computer, a network computer, and a server computer.

30. The apparatus of claim 27, wherein said apparatus is at least one a personal computer,
a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

31. An apparatus for providing shipment information, comprising:
a receiver for receiving at least one of provider position information, provider location information and provider available cargo capacity information;
a processor for processing said at least one of provider position information, provider location information and provider available cargo capacity information, in conjunction with information regarding requests for at least one of shipment services and delivery services, wherein said processor generates a report containing information regarding at least one of a shipment assignment, shipment assignments, a shipment job, shipment jobs, a delivery assignment, delivery assignments, a delivery job, and delivery jobs, which can match an availability of a provider; and
a transmitter for transmitting said report to a communication device associated with at least one of a provider and a provider's representative.

32. The apparatus of claim 31, wherein said apparatus is at least one of a central processing computer, a network computer, and a server computer.

33. The apparatus of claim 32, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

34. The apparatus of claim 31, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

35. An apparatus for providing shipment information, comprising:
a transmitter for transmitting at least one of provider position information, provider location information and provider available cargo capacity information, along with information regarding provider availability to fulfill at least one of an available shipment requirement and an available delivery requirement to a central processing computer;
a receiver for receiving a report containing information regarding at least one of a shipment assignment, shipment assignments, a shipment job, shipment jobs, a delivery assignment, delivery assignments, a delivery job, and delivery jobs, which can match the availability of a provider;
a processor for processing the information contained in said report; and
a display device for displaying at least some of the information contained in said report.

36. The apparatus of claim 35, wherein the central processing computer is at least one of a central processing computer, a network computer, and a server computer.

37. The apparatus of claim 35, wherein said apparatus is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

38. The apparatus of claim 35, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

39. An apparatus for providing shipment information, comprising:
a receiver for receiving at least one of client position information, a client shipment requirement, and a client delivery requirement;
a processor for processing said at least one of client position information, a client shipment requirement, and a client delivery requirement, in conjunction with information regarding available providers of one of shipment services and delivery services, wherein said processor generates a report containing information regarding at least one available provider which can match a client one of shipment requirement and delivery requirement; and
a transmitter for transmitting said report to a communication device associated with at least one of a client and a client's representative.

40. The apparatus of claim 39, wherein said apparatus is at least one of a central processing computer, a network computer, and a server computer.

41. The apparatus of claim 39, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

42. The apparatus of claim 39, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

43. An apparatus for providing shipment information, comprising:
a transmitter for transmitting at least one of client position information, client location information, and a client's at least one of a shipment requirement and a delivery requirement along with a request for an available provider, wherein said at least one of information, requirement and request, is transmitted to a central processing computer;
a receiver for receiving a report containing information regarding at least one of an available provider which can match a client at least one of shipment requirement and delivery requirement;
a processor for processing the information contained in said report; and
a display device for displaying at least some of the information contained in said report.

44. The apparatus of claim 43, wherein the central processing computer is at least one of a central processing computer, a network computer, and a server computer.

45. The apparatus of claim 43, wherein said apparatus is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

46. The apparatus of claim 43, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

47. An apparatus for providing shipment information, comprising:
a receiver for receiving at least one of provider position information, provider location information and provider available cargo capacity information;
a processor for processing said at least one of provider position information, provider location information and provider available cargo capacity information, in conjunction with information regarding a client having a request for at least one of shipment service and delivery service, wherein said processor generates at least one of a digitized map and digitized map information containing the position of at least one client having at least one of a shipment requirement and a delivery requirement; and
a transmitter for transmitting said at least one of a digitized map and digitized map information to a communication device associated with at least one of a provider and a provider's representative.

48. The apparatus of claim 47, wherein said at least one of a digitized map and digitized map information contains at least one of position information and location information for at least one of a provider, providers, and a requesting individual.

49. The apparatus of claim 47, wherein said apparatus is at least one of a central processing computer, a network computer, and a server computer.

50. The apparatus of claim 47, wherein the communication device is at least one a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

51. The apparatus of claim 47, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

52. An apparatus for providing shipment information, comprising:
a transmitter for transmitting at least one of provider position information, provider location information and provider available cargo capacity information, to a central processing computer;
a receiver for receiving at least one of a digitized map and digitized map information, wherein said at least one of a digitized map and digitized map information contains the position of at least one client having at least one of a shipment requirement and a delivery requirement;
a processor for processing said at least one of a digitized map and digitized map information; and
a display device for displaying said at least one of a digitized map and digitized map information.

53. The apparatus of claim 52, wherein said at least one of a digitized map and digitized map information contains at least one of position information and location information for at least one of a provider, providers, and a requesting individual.

54. The apparatus of claim 52, wherein the central processing computer is at least one of a central processing computer, a network computer, and a server computer.

55. The apparatus of claim 52, wherein said apparatus is at least one a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

56. The apparatus of claim 52, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

57. An apparatus for providing shipment information, comprising:
a receiver for receiving at least one of client position information, client location information and client at least one of a shipment requirement and a delivery requirement;
a processor for processing said at least one of client position information, client location information and client at least one of a shipment requirement and a delivery requirement, in conjunction with information regarding provider availability, wherein said processor generates at least one of a digitized map and digitized map information containing the position of at least one provider available to service a client at least one of a shipment requirement and a delivery requirement; and
a transmitter for transmitting said at least one of a digitized map and digitized map information to a communication device associated with at least one of a client and a client's representative.

58. The apparatus of claim 57, wherein said at least one of a digitized map and digitized map information contains at least one of position information and location information for at least one of a client, clients, and a requesting individual.

59. The apparatus of claim 57, wherein said apparatus is at least one of a central processing computer, a network computer, and a server computer.

60. The apparatus of claim 57, wherein the communication device is at least one a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

61. The apparatus of claim 57, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

62. An apparatus for providing shipment information, comprising:
a transmitter for transmitting at least one of client position information, client location information and at least one of a client shipment requirement and a client delivery requirement;
a receiver for receiving at least one of a digitized map and digitized map information, wherein said at least one of a digitized map and digitized map information contains the position of at least one provider available for handling said at least one of a client shipment requirement and a client delivery requirement;
a processor for processing said at least one of a digitized map and digitized map information; and
a display device for displaying said at least one of a digitized map and digitized map information.

63. The apparatus of claim 62, wherein said at least one of a digitized map and digitized map information contains at least one of position information and location information for at least one of a client, clients, and a requesting individual.

64. The apparatus of claim 62, wherein the central processing computer is at least one of a central processing computer, a network computer, and a server computer.

65. The apparatus of claim 62, wherein said apparatus is at least one a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

66. The apparatus of claim 62, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

67. An apparatus for providing shipment information, comprising:
a receiver for receiving at least one of a search parameter, a search instruction, and a request for notification, regarding at least one of a shipment and a delivery, wherein said at least one of a search parameter, a search instruction, and a request for notification, regarding at least one a shipment and a delivery is received from a requesting individual;
a processor for processing said at least one of a search parameter, a search instruction, and a request for notification, in conjunction with information regarding at least one of a client shipment requirement and a client delivery requirement, wherein said processor generates a notification message for providing a notification to the requesting individual regarding said at least one of a client shipment requirement and a client delivery requirement; and
a transmitter for transmitting said notification message to a communication device associated with the requesting individual.

68. The apparatus of claim 67, wherein said processor at least one of processes said at least one of a search parameter, a search instruction, and a request for notification, in conjunction with information regarding at least one of a client shipment requirement and a client delivery requirement, and generates said notification message in response to a search event.

69. The apparatus of claim 67, wherein said apparatus is at least one of a central processing computer, a network computer, and a server computer.

70. The apparatus of claim 67, wherein the communication device is at least one a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

71. The apparatus of claim 67, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

72. An apparatus for providing shipment information, comprising:
a transmitter for transmitting at least one of a search parameter, a search instruction, and a request for notification, regarding at least one of a shipment and a delivery, wherein said at least one of a search parameter, a search instruction, and a request for notification, regarding at least one a shipment and a delivery is transmitted to a central processing computer;
a receiver for receiving a notification message, wherein said notification message is generated in response to an occurrence of a search event;
a processor for processing said notification message; and
a display device for displaying information contained in said notification message.

73. The apparatus of claim 72, wherein the central processing computer is at least one of a central processing computer, a network computer, and a server computer.

74. The apparatus of claim 72, wherein said apparatus is at least one a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

75. The apparatus of claim 72, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

76. An apparatus for providing shipment information, comprising:
a receiver for receiving at least one of a search parameter, a search instruction, and a request for notification, regarding at least one of a provider and an availability of a provider;
a processor for processing said at least one of a search parameter, a search instruction, and a request for notification, in conjunction with information regarding said at least one of a provider and an availability of a provider, wherein said processor generates a notification message for providing a notification to a requesting individual regarding said at least one of a provider and an availability of a provider; and
a transmitter for transmitting said notification message to a communication device associated with the requesting individual.

77. The apparatus of claim 76, wherein said processor at least one of processes said at least one of a search parameter, a search instruction, and a request for notification, in conjunction with information regarding said at least one of a provider and an availability of a provider.

78. The apparatus of claim 76, wherein said apparatus is at least one of a central processing computer, a network computer, and a server computer.

79. The apparatus of claim 76, wherein the communication device is at least one of a communication device, a personal digital assistant, a telephone, a wireless telephone, a digital telephone, a third generation (3G) telephone, a video telephone, a television, an interactive television, a beeper, a pager, and a watch.

80. The apparatus of claim 76, wherein said apparatus is utilized at least one of on and or at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

81. An apparatus for providing shipment information, comprising:
a transmitter for transmitting at least one of a search parameter, a search instruction, and a request for notification, regarding at least one of a provider and provider availability, wherein said at least one of a search parameter, a search instruction, and a request for notification, regarding at least one of a provider and a provider availability is transmitted to a central processing computer;
a receiver for receiving a notification message, wherein said notification message is generated in response to an occurrence of a search event;
a processor for processing said notification message; and
a display device for displaying information contained in said notification message.

82. The apparatus of claim 81, wherein the central processing computer is at least one of a central processing computer, a network computer, and a server computer.

83. The apparatus of claim 81, wherein said apparatus is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

84. The apparatus of claim 81, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

85. An apparatus for providing shipment information, comprising:
a receiver for receiving at least one of a request for information and a request for a service related to at least one of a formation, an execution, and a satisfaction, of an agreement related to a shipment service arrangement between at least two parties, wherein said request is received from a requesting individual;
a memory device for storing information for processing said request and for providing at least one of information, a form, and a document, for servicing said request;
a processor for processing said request, wherein said processor generates at least one of information, a document, and a form, for facilitating a shipment service contract; and
a transmitter for transmitting said at least one of information, a document, and a form, for facilitating a shipment service contract, to at least one party to a shipment service at least one of contract, agreement and arrangement.

86. The apparatus of claim 85, wherein said transmitter transmits said at least one of information, a document, and a form, for facilitating a shipment service contract to at least two parties to at least one of a contract, an agreement, and an arrangement.

87. The apparatus of claim 85, wherein said apparatus obtains a digital signature from at least one party to said at least one of a contract, an agreement, and an arrangement.

88. The apparatus of claim 85, wherein said processor generates at least one of information, a form, and a document, at least one of related to, referenced by, and ancillary to, said at least one of a contract, an agreement, and an arrangement.

89. The apparatus of claim 85, wherein said apparatus is at least one of a central processing computer, a network computer, and a server computer.

90. The apparatus of claim 85, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

91. The apparatus of claim 85, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

92. An apparatus for providing shipment information, comprising:
a transmitter for transmitting a request for at least one of information and a request for a service related to at least one of a formation, an execution, and a satisfaction, of an agreement related to a shipment service arrangement between at least two parties, wherein said request is transmitted to a central processing computer;
a receiver for receiving at least one of information, a document, and a form, in response to said request;
a processor for processing said at least one of information, a document, and a form, in response to said request; and
a display device for displaying said at least one of information, a document, and a form.

93. The apparatus of claim 92, further comprising:
a printer for printing said at least one of information, a document, and a form.

94. The apparatus of claim 92, wherein said processor attaches a digital signature to said at least one of information, a document, and a form.

95. The apparatus of claim 92, wherein said at least one of information, a document, and a form, is at least one of related to, referenced by, and ancillary to, said at least one of a contract, an agreement, and an arrangement.

96. The apparatus of claim 92, wherein the central processing computer is at least one of a central processing computer, a network computer, and a server computer.

97. The apparatus of claim 92, wherein said apparatus is at least one a personal computer, a hand-held computer, a palmtop computer, a laptop computer, a personal communication device, a personal digital assistant, a telephone, a wireless telephone, a digital telephone, a third generation (3G) telephone, a video telephone, a television, an interactive television, a beeper, a pager, and a watch.

98. The apparatus of claim 92, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

99. The apparatus of claim 23, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

100. The apparatus of claim 27, wherein said apparatus is utilized at least one of on and over at least one of the Internet, the World Wide Web, a communication network, a telephone communication network, a cellular communication network, a digital communication network, a personal communication network, a personal communication services (PCS) network, a third generation (3G) communication network, a satellite communication network, a broad band communication network, a low earth orbiting (LEO) satellite network, and a public switched telephone network.

101. A method for providing shipment information, comprising:
receiving a request to obtain information regarding at least one of a shipment and a delivery, wherein said request is received from a requesting individual;
processing said request to obtain information in conjunction with information regarding at least one of a shipment assignment, a shipment job, a delivery assignment, and a delivery job;
generating a report in response to said request for information; and
transmitting said report to a communication device associated with the requesting individual.

102. A method for providing shipment information, comprising:
transmitting a request to obtain information regarding at least one of a shipment and a delivery from a requesting individual to a central processing computer;
receiving a report from the central processing computer in response to said request for information;
processing said report; and
displaying information contained in said report.

103. A method for providing shipment information, comprising:
receiving a request to obtain information regarding at least one of a provider of at least one of shipment and delivery services and an availability of a provider of at least one of shipment and delivery services, wherein said request is received from a requesting individual;
processing said request to obtain information in conjunction with information regarding at least one of a provider, providers, an available provider, and available providers;
generating a report in response to said request for information; and
transmitting said report to a communication device associated with the requesting individual.

104. A method for providing shipment information, comprising:
transmitting a request to obtain information regarding at least one a provider, providers, an available provider, and available providers, to a central processing computer;
receiving a report from the central processing computer in response to said request for information;
processing said report; and
displaying information contained in said report.

105. A method for providing shipment information, comprising:
receiving a request to obtain information regarding at least one of an auction and a bidding process, wherein said request is received from a requesting individual;
processing said request in conjunction with information regarding at least one of an auction, auctions, a bidding process, and bidding processes;
generating a report regarding said at least one of an auction, auctions, a bidding process, and bidding processes, wherein said report contains at least one of time, place, site, and subject matter, of at least one of said at least one of an auction, auctions, a bidding process, and bidding processes; and
transmitting said report to a communication device associated with the requesting individual.

106. A method for providing shipment information, comprising:
transmitting a request to obtain information regarding at least one of an auction and a bidding process to a central processing computer;
receiving a report, wherein said report contains at least one of time, place, site, and subject matter, of at least one of said at least one of an auction, auctions, a bidding process, and bidding processes;
processing said information contained in said report; and
displaying at least a portion of said information contained in said report.

107. A method for providing shipment information, comprising:
receiving at least one of provider position information, provider location information and provider available cargo capacity information;
processing said at least one of provider position information, provider location information and provider available cargo capacity information, in conjunction with information regarding requests for at least one of shipment services and delivery services;
generating a report containing information regarding at least one of a shipment assignment, shipment assignments, a shipment job, shipment jobs, a delivery assignment, delivery assignments, a delivery job, and delivery jobs, which can match an availability of a provider; and
transmitting said report to a communication device associated with at least one of a provider and a provider's representative.

108. A method for providing shipment information, comprising:
transmitting at least one of provider position information, provider location information and provider available cargo capacity information, along with information regarding provider availability to fulfill at least one of an available shipment requirement and an available delivery requirement to a central processing computer;
receiving a report containing information regarding at least one of a shipment assignment, shipment assignments, a shipment job, shipment jobs, a delivery assignment, delivery assignments, a delivery job, and delivery jobs, which can match the availability of a provider;
processing the information contained in said report; and
displaying at least some of the information contained in said report.

109. A method for providing shipment information, comprising:
receiving at least one of client position information, a client shipment requirement, and a client delivery requirement;
processing said at least one of client position information, a client shipment requirement, and a client delivery requirement, in conjunction with information regarding available providers of one of shipment services and delivery services;
generating a report containing information regarding at least one available provider which can match a client one of shipment requirement and delivery requirement; and
transmitting said report to a communication device associated with at least one of a client and a client's representative.

110. A method for providing shipment information, comprising:
transmitting at least one of client position information, client location information, and a client's at least one of a shipment requirement and a delivery requirement along with a request for an available provider, wherein said at least one of information, requirement and request, is transmitted to a central processing computer;
receiving a report containing information regarding at least one of an available provider which can match a client at least one of shipment requirement and delivery requirement;
processing the information contained in said report; and
displaying at least some of the information contained in said report.

111. A method for providing shipment information, comprising:
receiving at least one of provider position information, provider location information and provider available cargo capacity information;
processing said at least one of provider position information, provider location information and provider available cargo capacity information, in conjunction with information regarding a client having a request for at least one of shipment service and delivery service;
generating at least one of a digitized map and digitized map information containing the position of at least one client having at least one of a shipment requirement and a delivery requirement; and
transmitting said at least one of a digitized map and digitized map information to a communication device associated with at least one of a provider and a provider's representative.

112. A method for providing shipment information, comprising:
transmitting at least one of provider position information, provider location information and provider available cargo capacity information, to a central processing computer;
receiving at least one of a digitized map and digitized map information, wherein said at least one of a digitized map and digitized map information contains the position of at least one client having at least one of a shipment requirement and a delivery requirement;
processing said at least one of a digitized map and digitized map information; and
displaying said at least one of a digitized map and digitized map information.

113. A method for providing shipment information, comprising:
receiving at least one of client position information, client location information and client at least one of a shipment requirement and a delivery requirement;
processing said at least one of client position information, client location information and client at least one of a shipment requirement and a delivery requirement, in conjunction with information regarding provider availability;
generating at least one of a digitized map and digitized map information containing the position of at least one provider available to service a client at least one of a shipment requirement and a delivery requirement; and
transmitting said at least one of a digitized map and digitized map information to a communication device associated with at least one of a client and a client's representative.

114. A method for providing shipment information, comprising:
transmitting at least one of client position information, client location information and at least one of a client shipment requirement and a client delivery requirement;
receiving at least one of a digitized map and digitized map information, wherein said at least one of a digitized map and digitized map information contains the position of at least one provider available for handling said at least one of a client shipment requirement and a client delivery requirement;
processing said at least one of a digitized map and digitized map information; and
displaying said at least one of a digitized map and digitized map information.

115. A method for providing shipment information, comprising:
receiving at least one of a search parameter, a search instruction, and a request for notification, regarding at least one of a shipment and a delivery, wherein said at least one of a search parameter, a search instruction, and a request for notification, regarding at least one a shipment and a delivery is received from a requesting individual;
processing said at least one of a search parameter, a search instruction, and a request for notification, in conjunction with information regarding at least one of a client shipment requirement and a client delivery requirement;
generating a notification message for providing a notification to the requesting individual regarding said at least one of a client shipment requirement and a client delivery requirement; and
transmitting said notification message to a communication device associated with the requesting individual.

116. A method for providing shipment information, comprising:
transmitting at least one of a search parameter, a search instruction, and a request for notification, regarding at least one of a shipment and a delivery, wherein said at least one of a search parameter, a search instruction, and a request for notification, regarding at least one a shipment and a delivery is transmitted to a central processing computer;
receiving a notification message, wherein said notification message is generated in response to an occurrence of a search event;
processing said notification message; and
displaying information contained in said notification message.

117. A method for providing shipment information, comprising:
receiving at least one of a search parameter, a search instruction, and a request for notification, regarding at least one of a provider and an availability of a provider;
processing said at least one of a search parameter, a search instruction, and a request for notification, in conjunction with information regarding said at least one of a provider and an availability of a provider;
generating a notification message for providing a notification to a requesting individual regarding said at least one of a provider and an availability of a provider; and
transmitting said notification message to a communication device associated with the requesting individual.

118. A method for providing shipment information, comprising:
transmitting at least one of a search parameter, a search instruction, and a request for notification, regarding at least one of a provider and provider availability, wherein said at least one of a search parameter, a search instruction, and a request for notification, regarding at least one of a provider and a provider availability is transmitted to a central processing computer;
receiving a notification message, wherein said notification message is generated in response to an occurrence of a search event;
processing said notification message; and
displaying information contained in said notification message.

119. A method for providing shipment information, comprising:
receiving at least one of a request for information and a request for a service related to at least one of a formation, an execution, and a satisfaction, of an agreement related to a shipment service arrangement between at least two parties, wherein said request is received from a requesting individual;
storing information for processing said request and for providing at least one of information, a form, and a document, for servicing said request;
processing said request;
generating at least one of information, a document, and a form, for facilitating a shipment service contract; and
transmitting said at least one of information, a document, and a form, for facilitating a shipment service contract, to at least one party to a shipment service at least one of contract, agreement and arrangement.

120. A method for providing shipment information, comprising:
transmitting a request for at least one of information and a request for a service related to at least one of a formation, an execution, and a satisfaction, of an agreement related to a shipment service arrangement between at least two parties, wherein said request is transmitted to a central processing computer;
receiving at least one of information, a document, and a form, in response to said request;
processing said at least one of information, a document, and a form; and
displaying said at least one of information, a document, and a form.
